(19) United States
(12) Patent Application Publication
(10) Pub. No.: US 2026/0274655 A1
(43) Pub. Date: Sep. 17, 2026

(54) HYDROGEN STORE

(71) Applicant: Schott AG, Mainz (DE)

(72) Inventors: Ulrich Fotheringham, Mainz (DE); Bernd Rüdinger, Mainz (DE); Inge Burger, Mainz (DE); Simone Monika Ritter, Mainz (DE); Christoph Gross, Mainz (DE); Joachim Deubener, Goslar (DE); Ralf Müller, Berlin (DE)

(73) Assignee: Schott AG, Mainz (DE)

(21) Appl. No.: 18/994,965

(22) PCT Filed: Jun. 29, 2023
(86) PCT No.: PCT/EP2023/067872

§ 371 Date: Jan. 15, 2025

(30) Foreign Application Priority Data
Jul. 15, 2022 (DE) 10 2022 117 797.1
May 5, 2023 (DE) 10 2023 111 825.0

(51) Int. Cl. C01B 3/0078; B32B 7/027; B32B 17/06; C03C 14/00

(52) U.S. Cl. CPC C01B 3/0078; B32B 7/027; B32B 17/06; C03C 14/002; B32B 2307/30; B32B 2307/724; C03C 2214/02

(57) ABSTRACT

The invention relates to a hydrogen store having little weight and low hydrogen permeability. The invention also relates to a combination material comprising a barrier material and a reinforcing material. The combination material can especially be used for walls in stores for molecular hydrogen.

### CROSS-REFERENCE TO RELATED APPLICATIONS

This application is a national stage entry under 35 U.S.C. § 371 of International Patent Application No. PCT/EP2023/067872 entitled “HYDROGEN STORE” and filed on Jun. 29, 2023, which is incorporated in its entirety herein by reference. International Patent Application No. PCT/EP2023/067872 claims priority to German Patent Application No. 10 2022 117 797.1 filed on Jul. 15, 2022, and German Patent Application No. 10 2023 111 825.0 filed on May 5, 2023, both of which are incorporated in their entirety herein by reference.

### BACKGROUND OF THE INVENTION

### 1. Technical Field of the Invention

The invention relates to a hydrogen storage medium having low weight and low hydrogen permeability. The invention also relates to a combination material comprising a barrier material and a reinforcing material. The combination material may especially be used as a wall in storage media for molecular hydrogen.

### 2. Description of the Related Art

There are essentially four technologies for hydrogen storage:
high pressure technology
cryotechnology (liquid hydrogen)
cryocompression technology
chemisorption or adsorption technology

High pressure typically means here pressures up to 700 bar; see Materials 2019, 12, 1973, although the intention is to go up to 1000 bar; see Int. J. Hydrogen Energy March 2017, 42(11): 7254-62. The requisite compression of the hydrogen consumes roughly 10%-15% of the energy to be stored depending on the pressure; see Int. J. of Hydrogen Energy 2021, 46(29), 15671-15690.

When made from steel, the corresponding tanks typically have dimensions and working pressures of diameter 220 mm, wall thickness 9.1 mm, working pressure 280 bar, or diameter 470 mm, wall thickness 26 mm, working pressure 410 bar; see International Journal of Hydrogen Energy 2017, 42(19), 13777-13788. A typical material question that arises in the case of pressure vessels involving metal relates to the hydrogen embrittlement of the metals; see International Int. J. of Hydrogen Energy 2021, 46(29), 15671-15690.

In the current type IV hydrogen storage media, weight is saved by ensuring mechanical integrity by means of carbon fiber structures rather than by means of metals; see Materials 2019, 12, 1973. These have to be bonded in turn to a barrier material, called a liner, for example by coating or lamination, the hydrogen permeability of which is of course of crucial importance. A further typical material question relating to these hydrogen storage media therefore stems from the fact that the material composites in current use can break up, especially in the event of abrupt discharge (mechanical and thermal cause: change in temperature on compression and decompression); see Int. J. Hydrogen Energy 2018, 43(9), 4671-4680.

The high-pressure technique is one of the generally most favored storage techniques for mobile applications; see Materials 2019, 12, 1973.

N. Schramm, M. Neubert, M. D. Naumann, L. Ulke-Winter, L. Kroll and S. Nendel, Entwicklung eines kohlenstoffaserverstärkten Ringdruckbehälters zur Wasserstoffspeicherung [Development of a Carbon Fiber-Reinforced Ring Pressure Vessel for Hydrogen Storage], Fuel Cell Conference FC³, Chemnitz, Nov. 26-27, 2019, describes a prototype, the wall of which contains a 4 mm-thick “liner” of PE, adjoined on the outside by a CFRP shell having an average thickness of 13.5 mm. The abbreviation “CFRP” stands for “carbon fiber-reinforced plastic”. Typical values for the performance of such systems can be found in Yu Sun, Hong Lv, Wei Zhou, Cunman Zhang, Research on hydrogen permeability of polyamide 6 as the liner material for type IV hydrogen storage tank, International Journal of Hydrogen Energy 45 (2020) 24980-24990. The article examines, for example, the barrier effect of a 4 mm-thick “liner” of PA6 (polycaprolactam, known brand name “Perlon”). This also takes account of the pressure dependence of the barrier effect. At room temperature and with single-sided application of a pressure of 25 MPa, permeability is 5.6·10⁻¹⁶ mol/(m·s·Pa); with single-sided application of a pressure of 50 MPa it is 1.4-10⁻¹⁶ mol/(m·s·Pa). Accordingly, the H₂ flow rate through a 4 mm-thick “liner” in the first case is 3.5·10⁻⁶ mol/(m²·s), and in the second case 1.8·10⁻⁶ mol/(m²·s). By way of comparison, Sun et al. report the maximum permissible permeability of a material suitable for “liners” according to ISO19881-2018, cited by these authors, as 1.24-10⁻¹⁵ mol/(m·s·Pa). Sun et al. also describe a PA6 “liner” with a filler.

An overview of various “liner” materials is given by R. R. Barth, K. L. Simmons, C. San Marchi, Polymers for Hydrogen Infrastructure and Vehicle Fuel Systems: Applications, Properties, and Gap Analysis, Sandia Report SAND2013-8904 (Sandia National Laboratories, USA). But essentially only high density polyethylene (HDPA) and polyamide (PA) are used; see Winoj Balasooriya, Clara Clute, Bernd Schrittesser, and Gerald Pinter, A Review on Applicability, Limitations, and Improvements of Polymeric Materials in High-Pressure Hydrogen Gas Atmospheres, Polymer Reviews, Vol. 62, No. 1, 2022, 175-209.

Cryotechnology, the second technology mentioned above, has the disadvantage that, at the start of hydrogen storage, a considerably greater energy expenditure is for the liquefaction of the hydrogen than in the case of high-pressure technology, up to 40% of the energy stored, and the temperature has to be kept at below −253° C.; see Int. J. Hydrogen Energy March 2017, 42(11): 7254-62. Pressure vessels having an additional thermal insulation layer are used. This technology is of interest for stationary systems, where this insulation layer can be designed such that the losses via evaporation through a safety valve (“boil-off”) that occur as a result of the heat flux which is nevertheless unavoidable are very small; see Materials 2019, 12, 1973, or for applications in which high energy density is crucial, for example space travel; see Int. J. Hydrogen Energy March 2017, 42(11): 7254-62, or aviation; see Materials 2019, 12, 1973.

In cryocompression technology, the above-described pressure vessel is built such that it can withstand even very high pressures up to 300 bar, for example; this considerably reduces the boil-off losses (at the same temperature) compared to cryotechnology; see Int. J. Hydrogen Energy March 2017, 42(11): 7254-62. Cryocompression storage media can also be operated at temperatures that are low but above the boiling point of hydrogen; see Int. J. Hydrogen Energy March 2017, 42(11): 7254-62. By comparison with storage at room temperature, this makes use of the fact that, for gases at the same pressure, the molar amount is proportional to the reciprocal temperature, and hence increases the amount of stored hydrogen per unit volume. Such pressure vessels, as in the case of high-pressure storage at room temperature, may be built using carbon fiber technology with an appropriate “liner”; see Int. J. Hydrogen Energy March 2017, 42(11): 7254-62.

There are a wide variety of different approaches in the field of chemisorption or adsorption. One involves the binding of hydrogen to magnesium that takes place under specific pressure and temperature conditions, and corresponding storage as magnesium hydride; see Materials 2019, 12, 1973. In addition to the process-related energy losses here, there is also the standard enthalpy of formation of the hydride, but this is roughly only about 10% of the enthalpy of combustion of hydrogen. Storage is effected in low-pressure vessels, for example at 15 bar; see Int. J. Hydrogen Energy 2010, 35(12), 6311-6322, where the pressure is intended to counteract dissociation of the hydride.

### SUMMARY OF THE INVENTION

It is an object of the invention to improve the storage of hydrogen.

The present invention relates to a hydrogen storage medium, especially a mobile hydrogen storage medium, for example for motor vehicles (especially for a car, for a truck, for a bus or for a motorcycle), for rail vehicles (especially for a passenger train or for a goods train), for aircraft (especially for airplanes or for helicopters), or for watercraft (especially for passenger ships, container ships or tankers). A mobile hydrogen storage medium may especially be a hydrogen tank or a sorption storage medium.

In the course of efforts to achieve substantial independence from fossil fuels, such as coal, oil or gas, the use of hydrogen is a future technology having great potential for growth. Especially in the case of mobile hydrogen storage media that can be used in any kind of vehicles, however, it is of great importance for the weight of the hydrogen storage media to be minimized in order to assure good efficiency of the technology. Mobile hydrogen storage media having high weight are disadvantageous since the weight of the hydrogen storage medium always has to be carried as well, which is associated with elevated energy consumption.

Against this background, the present invention provides hydrogen storage media having low weight. The hydrogen storage media of the invention comprise a combination material comprising a barrier material and a reinforcing material. The reinforcing material may especially be a fibrous material. The reinforcing material may especially comprise or consist of carbon fibers, silicon carbide fibers, aluminum oxide fibers, silicon oxide fibers or combinations of two or more of these. What is meant more particularly by carbon fibers, silicon fibers etc. is that carbon, silicon carbide etc. is the respective main component, i.e. the proportion thereof in the total weight of the fiber is more than 50% by weight, further preferably more than 60% by weight, further preferably more than 70% by weight, further preferably more than 80% by weight, further preferably more than 90% by weight, further preferably more than 95% by weight, further preferably more than 98% by weight, further preferably more than 99% by weight, further preferably 100% by weight or essentially 100% by weight; in addition to carbon, silicon carbide etc., the fibers may especially contain one or more components selected from the group consisting of oxygen, boron, titanium, zirconium, nitrogen and combinations of two or more of these.

The reinforcing material may also comprise glass fibers as used for glass fiber-reinforced plastics; the corresponding glasses are generally referred to as E glass, S glass, R glass, M glass, C glass, ECR glass, D glass, AR glass, or Q glass.

The reinforcing material may be a fiber-reinforced plastic, for example a carbon fiber-reinforced plastic (CFRP) or a glass fiber-reinforced plastic (GFRP). A fiber-reinforced plastic is a material composed of reinforcing fibers and a plastic matrix. The proportion by volume of fibers p is preferably in a range from 50% to 70% by volume, especially from 55% to 65% by volume or about 60% by volume. The proportion by volume of fibers P is preferably at least 50% by volume, at least 55% by volume, or at least 60% by volume. The proportion by volume of fibers p is preferably at most 70% by volume, at most 65% by volume, or preferably at most 60% by volume. The plastic matrix preferably comprises an epoxy resin or consists of an epoxy resin.

### BRIEF DESCRIPTION OF THE FIGURES

FIG. 1 shows a schematic of a predominantly superellipsoidal hydrogen storage medium 11 with a wall made from a combination material.

FIG. 2 shows a schematic of a predominantly superellipsoidal hydrogen storage medium 21 having a wall consisting partly of a combination material.

FIG. 3 shows a schematic of two bottle-shaped hydrogen storage media 31a and 31b having a wall consisting wholly or partly of a combination material.

### DETAILED DESCRIPTION OF THE INVENTION

In one aspect, the invention relates to a hydrogen storage medium, especially a mobile hydrogen storage medium, preferably a mobile hydrogen tank. The present invention provides a hydrogen storage medium having particularly low weight, which (more specifically: the wall thereof) nevertheless has particularly low hydrogen permeability.

The hydrogen storage medium of the invention preferably has a cavity in which the hydrogen can be stored. The cavity is surrounded by a wall. The wall is intended to prevent escape of the hydrogen. The thickness of the wall is especially in a range from 15 mm to 50 mm, for example from 20 mm to 45 mm, from 25 mm to 40 mm, or from 30 to 35 mm. The thickness of the wall should not be too small. Otherwise, the unwanted losses of hydrogen may be too great. The thickness of the wall is preferably at least 15 mm, at least 20 mm, at least 25 mm, or at least 30 mm. However, the thickness of the wall should not be too great either. Otherwise, there is an unwanted increase in weight of the hydrogen storage medium. This plays an important role particularly in the case of mobile hydrogen storage media, for example in the case of hydrogen tanks. The thickness of the wall is preferably at most 50 mm, at most 45 mm, at most 40 mm, or at most 35 mm.

The wall especially has at least one opening, for example at least one inlet and/or at least one outlet. The inlet and/or the outlet may be provided in two separate openings or in a common opening. The inlet serves for filling of the cavity with hydrogen. Hydrogen can leave the cavity through the outlet, for example in order to arrive at an energy converter, especially at a fuel cell. Hydrogen can serve as fuel, from which the energy converter can gain electrical energy, for example, especially in order to drive a vehicle. The openings in the wall are preferably provided with valves. This can control the entry of the hydrogen into the cavity and the exit of the hydrogen from the cavity.

A hydrogen storage medium, for example a hydrogen tank, is especially a vessel having a cavity in which hydrogen can be stored. The invention relates to such a vessel having a wall comprising a barrier material. The vessel or the wall thereof may especially have an inlet and/or an outlet. The vessel is especially a hydrogen storage medium (preferably a mobile hydrogen storage medium or hydrogen tank) or can be used as a hydrogen storage medium (preferably as a mobile hydrogen storage medium or hydrogen tank). The vessel or the wall thereof may consist of the barrier material. However, the wall preferably comprises one or more other materials, especially one or more reinforcing materials. The combination material comprising or consisting of barrier material and reinforcing material may either take the form of a material composite or of a composite material, especially also of a laminar structure. A material composite is thus in particular a layer composite. The combination material of the invention is preferably a material composite, especially a layer composite, preferably comprising or consisting of one or more barrier material layers and one or more reinforcing material layers. A composite material, by contrast with a material composite, is especially understood to mean a combination material that does not have any such layer structure or other macroscopically recognizable combination construction, for example a dispersion-reinforced plastic or a glass ceramic. The use of the reinforcing materials may be matched to the load conditions in the vessel.

In some embodiments of the invention, the entire wall of the hydrogen storage medium comprises a combination material comprising or consisting of a barrier material and a reinforcing material. It is also possible that the entire wall consists of a combination material comprising or consisting of a barrier material and a reinforcing material. A disadvantage of such configurations is the particular mechanical stability of the wall. Such a configuration, by contrast, may be disadvantageous in particular in the case of very high demands on particularly low weight.

In some embodiments of the invention, merely a portion of the wall comprises a combination material comprising or consisting of a barrier material and a reinforcing material. It is also possible that a portion of the wall consists of a combination material comprising or consisting of a barrier material and a reinforcing material. The portion of the wall which does not comprise any combination material may consist of the barrier material, for example. By virtue of such a configuration, it is possible to achieve an additional weight saving. It is possible to dispense with reinforcing material particularly in those parts of the wall where the barrier material in any case already has comparatively high stability because of the geometric configuration.

The wall preferably comprises, at least in parts or across the entire wall, a barrier material and a reinforcing material, for example a fibrous or fiber-containing reinforcing material, especially comprising or consisting of carbon fibers, for example a carbon fiber braid, and/or silicon carbide fibers and/or aluminum oxide or silicon oxide fibers. In embodiments of the invention, the vessel or the wall comprises a barrier material (especially with a cylindrical footprint) as winding core for a fiber braid, especially comprising or consisting of carbon fibers and/or silicon carbide fibers. The vessel may be a stationary vessel or a mobile vessel. Mobile vessels are, for example, tanks for vehicles, especially for motor vehicles (especially for a car, for a truck, for a bus or for a motorcycle), for rail vehicles (especially for a passenger train or for a goods train), for aircraft (especially for airplanes or for helicopters), or for watercraft (especially for passenger ships, container ships or tankers).

The term “hydrogen tank” relates in particular to a mobile hydrogen storage medium, for example for vehicles.

The vessel of the invention especially has a cavity surrounded by a wall. The thickness of the wall is especially in a range from 15 mm to 50 mm, for example from 20 mm to 45 mm, from 25 mm to 40 mm, or from 30 to 35 mm. The thickness of the wall is preferably at least 15 mm, at least 20 mm, at least 25 mm, or at least 30 mm. The thickness of the wall is preferably at most 50 mm, at most 45 mm, at most 40 mm, or at most 35 mm.

The thickness of the wall may be configured uniformly across the entire wall. It is also possible for the wall to have a thicker configuration specifically in the regions that require particular reinforcement than in the regions that do not require such reinforcement. Such variances in the thickness of the wall can be achieved, for example, by correspondingly varying the thickness of the barrier material. However, the thickness of the barrier material is preferably not a spatially variable parameter since “diffusion holes” would otherwise be created, i.e. regions having greater permeability for hydrogen. The variations in the thickness mentioned are therefore preferably based on provision of a thicker layer of reinforcing material or provision of a layer of reinforcing material at all.

The difference between the greatest thickness and the smallest thickness of the wall may also be referred to as total thickness variation of the wall. The total thickness variation of the wall is preferably in a range from 0.1 to 10 mm, for example from 0.2 to 5.0 mm or from 0.5 to 2.0 mm. The total thickness variation of the wall may, for example, be at least 0.1 mm, at least 0.2 mm or at least 0.5 mm. The total thickness variation of the wall may, for example, be at most 10 mm, at most 5.0 mm or at most 2.0 mm.

The wall has an inner surface and an outer surface. The inner surface is in contact with the cavity and, in the case of appropriate filling, accordingly also with the hydrogen present therein. The outer surface of the wall is correspondingly directed outward and accordingly separated from the cavity and any hydrogen present therein by the thickness of the wall.

According to this construction, the wall in any case has an inner layer. The inner layer is especially that layer which provides the inner surface of the wall. The wall may consist of the inner layer in its entirety or in particular regions, such that the inner layer provides both the inner surface and the outer surface of the wall, for example in regions where additional reinforcement is unimportant. In completely single-layer embodiments, preference is given to using a composite material comprising or consisting of the barrier material and the reinforcing material. Such a composite material may assume the function of the barrier material and the function of the reinforcing material.

However, the wall preferably also has an outer layer in addition to the inner layer. In such embodiments, the inner surface of the wall is provided by the inner layer and the outer surface of the wall is provided by the outer layer.

The inner layer preferably comprises or consists of a barrier material.

The inner layer of the invention is especially a two-dimensional material and hence nonfibrous. A fibrous configuration of the inner layer would be associated with an increase in hydrogen permeability, which should be avoided in accordance with the invention. Instead, hydrogen permeability should be low. Therefore, the inner layer is preferably nonfibrous. Preference is instead given to a two-dimensional configuration of the inner layer. The inner layer is preferably of layered configuration, for example in the form of a film or ply. The inner layer is thus preferably in the form of a layer, especially in the form of a film or ply. The inner layer is preferably essentially free of pores, gaps and/or holes. The inner layer is preferably a continuous layer.

The inner layer preferably has a thickness in a range from 0.02 mm to 5.0 mm, for example from 0.05 to 3.5 mm, from 0.1 to 2.5 mm, from 0.2 to 2.0 mm or from 0.5 to 1.2 mm. The thickness of the inner layer is preferably at least 0.02 mm, at least 0.05 mm, at least 0.1 mm, at least 0.2 mm or at least 0.5 mm. The thickness of the inner layer is preferably at most 5.0 mm, at most 3.5 mm, at most 2.5 mm, at most 2.0 mm or at most 1.2 mm.

The distance between the greatest thickness and the smallest thickness of the inner layer may also be referred to as total thickness variation of the inner layer. The total thickness variation of the inner layer is preferably in a range from 0.005 mm to 1.0 mm, for example from 0.01 to 0.75 mm, from 0.02 to 0.5 mm or from 0.05 to 0.25 mm. The total thickness variation of the inner layer is preferably at least 0.005, at least 0.01 mm, at least 0.02 mm or at least 0.05 mm. The total thickness variation of the inner layer is preferably at most 1.0 mm, at most 0.75 mm, at most 0.5 mm or at most 0.25 mm.

The outer layer preferably comprises or consists of a reinforcing material. The outer layer preferably has a thickness in a range from 10 mm to 35 mm, for example from 15 to 30 mm or from 20 to 25 mm. The thickness of the outer layer is preferably at least 10 mm, at least 15 mm or at least 20 mm. The thickness of the outer layer is preferably at most 35 mm, at most 30 mm or at most 25 mm.

The difference between the greatest thickness and the smallest thickness of the outer layer may also be referred to as total thickness variation of the outer layer. The total thickness variation of the outer layer is preferably in a range from 0.1 mm to 10 mm, for example from 0.2 to 5.0 mm or from 0.5 to 2.5 mm. The total thickness variation of the outer layer is preferably at least 0.1 mm, at least 0.2 mm or at least 0.5 mm. The total thickness variation of the outer layer is preferably at most 10 mm, at most 5.0 mm or at most 2.5 mm.

The volume of the cavity is especially in a range from 20 liters to 100 000 liters, preferably 50 liters to 50 000 liters, for example from 100 to 25 000 liters, from 200 to 10 000 liters, from 500 to 5000 liters or from 1000 to 2000 liters. The volume of the cavity is preferably at least 20 liters, further preferably at least 50 liters, for example at least 100 liters, at least 200 liters, at least 500 liters or at least 1000 liters.

The volume of the cavity is preferably at most 100 000 liters, further preferably at most 50 000 liters, for example at most 25 000 liters, at most 10 000 liters, at most 5000 liters or at most 2000 liters.

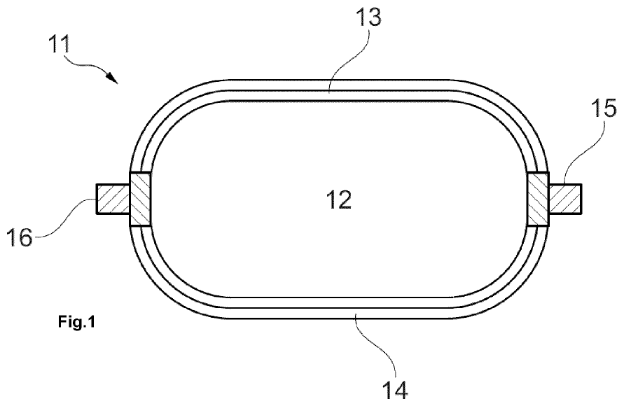

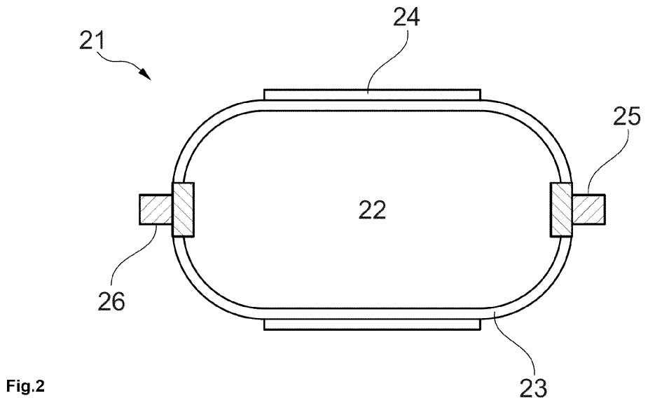

The vessel and especially the boundary of the cavity, i.e. the wall, may have various shapes. Preference is given to a superellipsoidal or predominantly superellipsoidal shape as shown by way of example in FIGS. 1 and 2. A superellipsoidal or predominantly superellipsoidal shape is particularly advantageous in order to withstand high pressures.

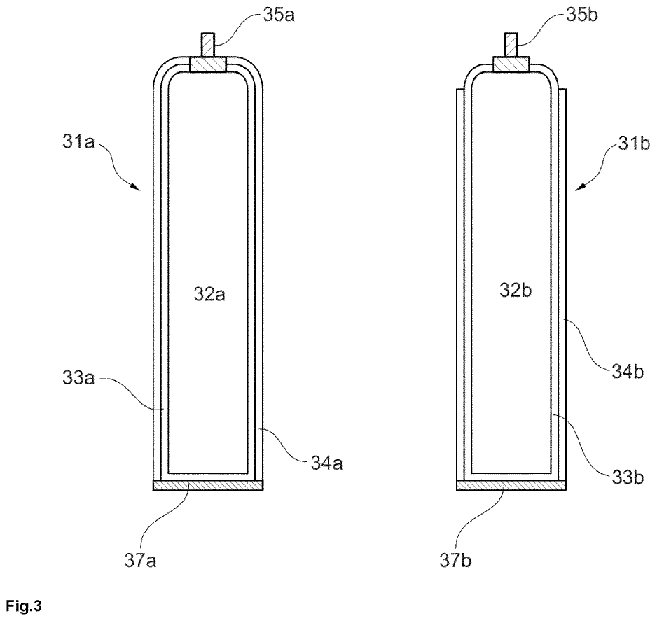

The same applies to a bottle-shaped configuration, which is likewise part of the present invention. A bottle-shaped configuration is shown, for example, in FIG. 3. In principle, complex shapes are possible (and in practice are indeed likely). The transitions from one shape to another are additionally often fluid. For example, a cylindrical footprint having a curvature on one side may thus be referred to as bottle-shaped.

The present invention relates in particular to a hydrogen storage medium having a wall surrounding a cavity. In a preferred embodiment, the wall consists of a combination material, especially a material composite comprising an inner barrier layer (i.e. one facing the cavity), comprising or consisting of a barrier material, and an outer reinforcing layer comprising or consisting of a reinforcing material. The reinforcing layer may especially be provided all round the barrier layer.

The hydrogen storage medium may comprise one or more valves, for example two valves. The valves may especially be provided on opposite sides of the hydrogen storage medium, for example on the short sides of the hydrogen storage medium.

The hydrogen storage medium, or the wall thereof, may especially be configured such that the shape of the wall is based on a cylindrical shape or on a cylindrical footprint. Based on a cylindrical footprint, various shapes can be created, for example a superellipsoidal or predominantly superellipsoidal shape or a bottle shape. In the case of a superellipsoidal or predominantly superellipsoidal shape, two short sides in particular are provided, which wholly or partly have convex curvature, where the middle of one short side may be a flat face. In the case of a bottle shape, one of the short sides is always configured as a base, on which the bottle-shaped hydrogen storage medium may be rested. The other short side may have any convex curvature. In a bottle-shaped embodiment, a valve is preferably provided on the arbitrarily convex-curved short side, which may especially be formed at the end of the hydrogen storage medium opposite the base. Bottle-shaped embodiments preferably contain only one valve.

In the case of a one-valve solution, the valve may especially be provided both as the inlet and as the outlet. In the case of a two-valve solution, for example in the case of a superellipsoidal or predominantly superellipsoidal shape of the hydrogen storage medium having two opposite convex-curved short sides, the two valves may especially be provided on the two short sides, i.e. in each case one valve on each of the two short sides. In the case of a multivalve solution such as a two-valve solution, it is possible, for example, to provide one of the valves as inlet and another of the valves as outlet. However, this is not necessarily the case. Even in the case of a multivalve solution such as a two-valve solution, it is possible to provide one of the valves both as inlet and as outlet. The other valve (in the case of a two-valve solution) or the other valves (in the case of an embodiment having three or more valves) may likewise be configured as inlet and/or as outlet. It is also possible to configure one or more of the valves as safety valve. A safety valve may be provided, for example, with a pressure sensor and may open in the event of exceedance of a pressure threshold in order to prevent the buildup of an unwanted positive pressure. What is meant in particular by “unwanted positive pressure” is a pressure that can be accompanied by damage to the integrity of the wall of the hydrogen storage medium, which can result in a creeping or even a spontaneous loss of relevant amounts of hydrogen from the cavity. A spontaneous loss may additionally be associated with the risk of damage to articles or parts of buildings in the vicinity, or of injury to persons in the vicinity. The buildup of an unwanted positive pressure should therefore preferably be avoided.

Such an unwanted positive pressure should not be confused with the target positive pressure which is desired for storage of the hydrogen and can be established in a controlled manner. In order to be able to withstand such a target positive pressure, high demands are made on the material of the wall of the hydrogen storage medium.

The vessel of the invention is especially suitable for the storage of hydrogen. For this purpose, the vessel, as described above, must be able to withstand high or very high pressures. The vessel preferably withstands a pressure of up to 10 bar, up to 25 bar, up to 50 bar, up to 100 bar, up to 200 bar, up to 300 bar, up to 400 bar, up to 500 bar, up to 600 bar, up to 700 bar, up to 800 bar, up to 900 bar, up to 1000 bar, up to 1200 bar or up to 1500 bar.

The wall of the hydrogen storage medium preferably comprises a combination material, especially a composite material or a material composite, or the wall consists of a combination material, especially of a composite material or of a material composite.

The present invention also relates to a combination material, especially to a composite material or a material composite, especially to a composite material or a material composite comprising or consisting of a barrier material and a reinforcing material.

The density of the reinforcing material is preferably in a range from 1.4 to 4.5 g/cm³, for example from 1.5 g/cm³ to 3.5 g/cm³, from 1.6 to 3.0 g/cm³ or from 1.7 to 2.5 g/cm³. The density of the reinforcing material is preferably at least 1.4 g/cm³, at least 1.5 g/cm³, at least 1.6 g/cm³ or at least 1.7 g/cm³. The density of the reinforcing material is preferably at most 4.5 g/cm³, at most 3.5 g/cm³, at most 3.0 g/cm³, or at most 2.5 g/cm³.

The ratio of the coefficients of thermal expansion of the barrier material compared to the reinforcing material is also significant. The difference in the average linear coefficient of thermal expansion (CTE) of the reinforcing material and the barrier material in a range from 20° C. to 300° C. is preferably in a range from 0.0 to 10.0 ppm/K, from 0.1 to 7.5 ppm/K, from 0.2 to 5.0 ppm/K, from 0.5 to 2.5 ppm/K, or from 1.0 to 2.0 ppm/K. The difference between the CTE of the reinforcing material and the CTE of the barrier material is preferably at most 10.0 ppm/K, at most 7.5 ppm/K, at most 5.0 ppm/K, at most 2.5 ppm/K, or at most 2.0 ppm/K. The difference between the CTE of the reinforcing material and the CTE of the barrier material may, for example, be about 0.0 ppm/K, at least 0.1 ppm/K, at least 0.2 ppm/K, at least 0.5 ppm/K, or at least 1.0 ppm/K. What is meant by “difference” is in particular the difference between the CTE of the reinforcing material and the CTE of the barrier material or the magnitude of that difference.

If the present disclosure makes reference to the “CTE”, this means the average linear coefficient of thermal expansion in a range from 20° C. to 300° C., unless stated otherwise. This applies both to measured values and to calculated values.

The reinforcing material serves in particular for mechanical reinforcement and therefore preferably has excellent mechanical properties.

The reinforcing material may have, for example, a tensile strength in a range from 1.5 GPa to 8.0 GPa, for example from 2.0 to 6.0 GPa, from 2.5 to 5.0 GPa or from 3.0 to 4.0 GPa. The tensile strength of the reinforcing material is preferably at least 1.5 GPa, at least 2.0 GPa, at least 2.5 GPa or at least 3.0 GPa. The tensile strength of the reinforcing material may be, for example, at most 8.0 GPa, at most 6.0 GPa, at most 5.0 GPa or at most 4.0 GPa.

The reinforcing material may have, for example, a modulus of elasticity of 120 GPa to 500 GPa, for example from 150 to 450 GPa, from 170 to 420 GPa, from 200 to 400 GPa, from 220 to 380 GPa or from 250 to 350 GPa. The modulus of elasticity of the reinforcing material may, for example, be at least 120 GPa, at least 150 GPa, at least 170 GPa, at least 200 GPa, at least 220 GPa or at least 250 GPa. The modulus of elasticity of the reinforcing material may, for example, be at most 500 GPa, at most 450 GPa, at most 420 GPa, at most 400 GPa, at most 380 GPa or at most 350 GPa.

Tensile strength, modulus of elasticity and further material indices can be determined in a method referred to as a tensile test. The result of the tensile test is the stress-strain diagram. The technical material indices can be read off therefrom. Depending on the material to be tested, the tensile test is described in different standards that are known to the person skilled in the art. The tensile properties of ceramic fibers can especially be determined according to DIN EN 1007-4:2004-08.

The reinforcing material may have, for example, an average linear coefficient of thermal expansion (CTE) in a range from −1.0 to 20.0 ppm/K of −0.5 to 15.0 ppm/K, or of −0.2 to 12.0 ppm/K. The CTE may, for example, be at least −1.0 ppm/K, at least −0.5 ppm/K or at least −0.2 ppm/K. The CTE may, for example, be at most 20.0 ppm/K, at most 15.0 ppm/K or at most 12.0 ppm/K.

In the case of fibrous reinforcing materials, the CTE in longitudinal direction may differ from the CTE in transverse direction. In particular, the CTE in longitudinal direction may be virtually zero or even negative. By contrast, the CTE in transverse direction may be much greater than in longitudinal direction.

The CTE in transverse direction is preferably in a range from 2.0 to 20.0 ppm/K, from 5.0 to 15.0 ppm/K or from 7.5 to 12.5 ppm/K. The CTE in transverse direction may, for example, be at least 2.0 ppm/K, at least 5.0 ppm/K or at least 7.5 ppm/K. The CTE in transverse direction may, for example, be at most 20.0 ppm/K, at most 15.0 ppm/K or at most 12.5 ppm/K.

The CTE in longitudinal direction is preferably in a range from −1.0 to 1.0 ppm/K, from −0.5 to 0.5 ppm/K or from −0.2 to 0.0 ppm/K. The CTE in longitudinal direction may, for example, be at least −1.0 ppm/K, at least −0.5 ppm/K or at least −0.2 ppm/K. The CTE in longitudinal direction may, for example, be at most 1.0 ppm/K, at most 0.5 ppm/K or at most 0.0 ppm/K.

The difference between the CTE of the reinforcing material in transverse direction and the CTE of the barrier material is preferably in a range from 0.0 to 10.0 ppm/K, from 0.1 to 7.5 ppm/K, from 0.2 to 5.0 ppm/K, from 0.5 to 2.5 ppm/K, or from 1.0 to 2.0 ppm/K. The difference between the CTE of the reinforcing material in transverse direction and the CTE of the barrier material is preferably at most 10.0 ppm/K, at most 7.5 ppm/K, at most 5.0 ppm/K, at most 2.5 ppm/K, or at most 2.0 ppm/K. The difference between the CTE of the reinforcing material in transverse direction and the CTE of the barrier material may, for example, be about 0.0 ppm/K, at least 0.1 ppm/K, at least 0.2 ppm/K, at least 0.5 ppm/K, or at least 1.0 ppm/K. What is meant by “difference” is in particular the difference between the CTE of the reinforcing material in transverse direction and the CTE of the barrier material or the magnitude of that difference.

The difference between the CTE of the barrier material and the CTE of the reinforcing material in longitudinal direction is preferably in a range from 1.0 to 12.5 ppm/K, from 2.5 to 10.0 ppm/K or from 5.0 to 7.5 ppm/K. The difference between the CTE of the barrier material and the CTE of the reinforcing material in longitudinal direction may, for example, be at least 1.0 ppm/K, at least 2.5 ppm/K or at least 5.0 ppm/K. The difference between the CTE of the barrier material and the CTE of the reinforcing material in longitudinal direction may, for example, be at most 12.5 ppm/K, at most 10.0 ppm/K or at most 7.5 ppm/K. What is meant by “difference” is in particular the difference between the CTE of the barrier material and the CTE of the reinforcing material in longitudinal direction or the magnitude of that difference.

The combination material of the invention, especially the composite material or the material composite, may comprise, for example, a barrier material and a reinforcing material or consist of a barrier material and a reinforcing material. The reinforcing material may especially be selected from the group consisting of carbon fibers, silicon carbide fibers, aluminum oxide fibers, silicon oxide fibers and combinations of two or more of these.

The combination material may, for example, be in the form of a material composite, especially in the form of a layer composite. In particular, a core (for example based on a cylindrical footprint) and a fiber braid surrounding the core may be provided, for example a fiber braid of carbon fibers and/or silicon carbide fibers and/or oxidic fibers. The core may also be referred to as inner layer and may comprise or consist of, for example, a barrier material.

The invention also provides barrier materials having (i) higher hydrogen imperviosity than the plastics currently used, which (ii) are suitable in terms of thermal expansion for a composite having fibrous reinforcing materials, especially carbon fiber structures, which (iii) make a small contribution to the weight of the overall system, and/or which (iv) have high fracture resistance.

The barrier material especially takes the form of a two-dimensional material. A two-dimensional material is in two-dimensional form and hence differs from a fiber. The two-dimensional material described herein is especially a film or a ply.

The barrier material of the invention is especially not a fibrous material. A configuration as a fibrous material would be associated with an increase in hydrogen permeability, which should be avoided in accordance with the invention. Instead, hydrogen permeability should be low. Therefore, the barrier material is preferably nonfibrous. Preference is instead given to a two-dimensional configuration of the barrier material. The barrier material is preferably layered. The barrier material is preferably a layer material or laminar material, for example a film or ply. The barrier material is thus preferably in the form of a layer, especially of a film or ply. The barrier layer is preferably essentially free of pores, gaps and/or holes. The barrier layer is preferably a continuous layer.

The barrier material of the invention preferably has particularly high hydrogen imperviosity. In other words, the hydrogen permeability of the barrier material is preferably particularly low.

The decadic logarithm of the H₂ permeability per mol/(m·s·Pa) of the wall of the hydrogen storage medium of the invention, of the combination material of the invention and/or of the barrier material of the invention, especially at a temperature of 473 K, is preferably less than −20.000, further preferably less than −20.100, further preferably less than −20.200, further preferably less than −20.300, further preferably less than −20.400, further preferably less than −20.500, further preferably less than −20.600, further preferably less than −20.700, further preferably less than −20.800, further preferably less than −20.900, further preferably less than −21.000, further preferably less than −21.250, further preferably less than −21.500, further preferably less than −21.750, further preferably less than −22.000, further preferably less than −22.250, further preferably less than −22.500, further preferably less than −22.750, further preferably less than −23.000, further preferably less than −23.250, further preferably less than −23.500, further preferably less than −23.750, further preferably less than −24.000. The decadic logarithm of the H₂ permeability per mol/(m·s·Pa) of the wall of the hydrogen storage medium of the invention, of the combination material of the invention and/or of the barrier material of the invention may, for example, be more than −29.000, more than −28.500, more than −28.000, more than −27.500, more than −27.000, more than −26.500, more than −26.000, more than −25.500, more than −25.000, or more than −24.500, especially at a temperature of 473 K.

The decadic logarithm of the H₂ permeability per mol/(m·s·Pa) of the wall of the hydrogen storage medium of the invention, of the combination material of the invention and/or of the barrier material of the invention, especially at a temperature of 473 K, may, for example, be in a range from more than −29.000 to less than −20.000, from more than −29.000 to less than −20.100, from more than −29.000 to less than −20.200, from more than −29.000 to less than −20.300, from more than −29.000 to less than −20.400, from more than −29.000 to less than −20.500, from more than −29.000 to less than −20.600, from more than −29.000 to less than −20.700, from more than −29.000 to less than −20.800, from more than −29.000 to less than −20.900, from more than −29.000 to less than −21.000, from more than −29.000 to less than −21.250, from more than −29.000 to less than −21.500, from more than −29.000 to less than −21.750, from more than −28.500 to less than −22.000, from more than −28.000 to less than −22.250, from more than −27.500 to less than −22.500, from more than −27.000 to less than −22.750, from more than −26.500 to less than −23.000, from more than −26.000 to less than −23.250, from more than −25.500 to less than −23.500, from more than −25.000 to less than −23.750, or from more than −24.500 to less than −24.000. H₂ permeability per mol/(m·s Pa) can be measured as described in Journal of Non-Crystalline Solids 394-395 (2014) 43-49.

The average linear coefficient of thermal expansion (CTE) of the barrier material in a range from 20° C. to 300° C. is preferably in a range from 3.5 to 9.5 ppm/K, from 4.0 to 9.0 ppm/K, from 4.5 to 8.5 ppm/K, or from 5.0 to 8.0 ppm/K. The CTE of the barrier material is preferably at least 3.5 ppm/K, at least 4.0 ppm/K, at least 4.5 ppm/K, or at least 5.0 ppm/K. The CTE of the barrier material is preferably at most 9.5 ppm/K, at most 9.0 ppm/K, at most 8.5 ppm/K, or at most 8.0 ppm/K. The CTE of the barrier material may especially be calculated or determined according to DIN ISO 7991:1998-02. The CTE of the reinforcing material may be determined according to DIN EN 16245:2013-08.

The density of the barrier material is preferably at most 2.70 g/cm³, further preferably at most 2.65 g/cm³, even further preferably at most 2.60 g/cm³. The density of the barrier material may, for example, be at least 2.20 g/cm³, at least 2.25 g/cm³, or at least 2.30 g/cm³. The by density of the barrier material may, for example, be in a range from 2.20 to 2.70 g/cm³, from 2.25 to 2.65 g/cm³ or from 2.30 to 2.60 g/cm³.

The fracture resistance of the barrier material is described by K1c, which is measured by the SEPB method as described in Journal of the European Ceramic Society 37 (2017) 4243-4257.

Glass is excellently suitable as part of the combination material of the invention, especially of the material composite, especially as barrier material. However, the glass should have low hydrogen permeability. Moreover, the CTE of the glass should not vary too greatly from the CTE of the reinforcing material of the combination material. The use of a glass as part of the combination material can permit the configuration of a particularly thin wall with sufficiently low hydrogen permeability, such that particularly lightweight hydrogen storage media and hydrogen tanks can be obtained, which is advantageous for tanks of vehicles of any kind for reasons of energy efficiency.

Glass is also advantageous for other reasons. In particular, hydrogen-related material aging is low. In addition, it is possible to produce combination materials, especially material composites made of glass on the one hand and carbon fibers, silicon carbide fibers and/or oxidic fibers on the other hand, where delamination does not occur to a relevant degree, if at all.

Especially when used in the or as barrier material, the glass of the invention is preferably in the form of a two-dimensional material and hence in nonfibrous form. A configuration of the glass of the invention in fibrous form would be associated with an increase in hydrogen permeability, which should be avoided in accordance with the invention. Instead, hydrogen permeability should be low. Therefore, the glass of the invention is preferably in nonfibrous form. Preference is given instead to a two-dimensional configuration of the glass of the invention. The glass of the invention is preferably in laminar configuration, for example in the form of a glass layer or a glass film. The glass of the invention is thus preferably in the form of a glass layer, especially in the form of a glass film. The use of the word “film” does not imply any limitation of layer thickness.

The invention relates to a glass article comprising or consisting of the glass of the invention. The glass article of the invention is preferably nonfibrous. Preference is given instead to a two-dimensional configuration of the glass article. The glass article is preferably in laminar configuration, for example in the form of a glass layer or a glass film. The glass article is thus preferably in the form of a glass layer, especially in the form of a glass film. The glass article is preferably a glass layer or a glass film.

The glass article preferably has a thickness in a range from 0.02 mm to 5.0 mm, for example from 0.05 to 3.5 mm, from 0.1 to 2.5 mm, from 0.2 to 2.0 mm or from 0.5 to 1.2 mm. The thickness of the glass article is preferably at least 0.02 mm, at least 0.05 mm, at least 0.1 mm, at least 0.2 mm or at least 0.5 mm. The thickness of the glass article is preferably at most 5.0 mm, at most 3.5 mm, at most 2.5 mm, at most 2.0 mm or at most 1.2 mm.

The difference between the greatest thickness and the smallest thickness of the glass article may also be referred to as total thickness variation of the glass article. The total thickness variation of the glass article is preferably in a range from 0.005 mm to 1.0 mm, for example from 0.01 to 0.75 mm, from 0.02 to 0.5 mm or from 0.05 to 0.25 mm. The total thickness variation of the glass article is preferably at least 0.005, at least 0.01 mm, at least 0.02 mm or at least 0.05 mm. The total thickness variation of the glass article is preferably at most 1.0 mm, at most 0.75 mm, at most 0.5 mm or at most 0.25 mm.

The invention also relates to a glass comprising the following components in the proportions reported (in mol %):

TABLE 1

| | Min (mol %) | Max (mol %) |
|---|---|---|
| SiO₂ | 50 | 75 |
| B₂O₃ | 0 | 25 |
| Al₂O₃ | 0 | 25 |
| MgO | 0 | 25 |
| Li₂O | 0 | 25 |
| Na₂O | 0 | 30 |
| K₂O | 0 | 25 |
| ΣR₂O | 0 | 30 |
| ΣRO | 0 | 25 |
| ΣR₂O + ΣRO | 10 | 30 |
| ΣLi₂O + MgO | 1 | 30 |

It has been found that glass is particularly readily suitable as barrier material when there is a minimum content of Li₂O and/or MgO. In addition, a minimum content of tetracoordinated boron is favorable, but not a content of tricoordinated boron. The glasses of the invention therefore have a total, based on the respective molar proportions, of at least just as large an amount of alkali metal oxides and alkaline earth metal oxides as Al₂O₃ and B₂O₃((ΣR₂O+ΣRO)≥(Al₂O₃+B₂O₃)).

The object is preferably additionally achieved by a specific combination of stoichiometric glasses, i.e. glasses that also exist as crystals in the same stoichiometry and the character of which, owing to the generally identical topology of the structural groups—as verified in the literature by many examples via NMR measurements or the like—can be assumed to be very similar for glass and for crystal. For this purpose, such stoichiometric glasses are selected, the mixture of which makes it possible to achieve behavior within the scope of achievement of the object of the invention. In the context of this application, these stoichiometric glasses are also referred to as “constituting phases”.

It is not a new concept to describe glasses on the basis of the constituting phases to be assigned to them (see, for example, EP 3 473 604 1 and DE 10 2017 102 482 B4). The specification of the base glasses permit conclusions as to the chemical structure of a glass (cf. Conradt R: “Chemical structure, medium range order, and crystalline reference state of multicomponent oxide liquids and glasses”, in Journal of Non-Crystalline Solids, volumes 345-346, Oct. 15, 2004, pages 16-23).

The present invention thus also relates to a glass having a composition characterized by the following phases that constitute the glass; this base system defined by the constituting phases is restricted in accordance with the invention by the specified composition ranges:

TABLE 2

| Constituting phase | Min (mol %) | Max (mol %) |
|---|---|---|
| Silicon dioxide | 0 | 50 |
| Sodium sheet silicate | 0 | 50 |
| Nepheline | 0 | 100 |
| Eucryptite | 0 | 100 |
| Cordierite | 0 | 100 |
| Malinkoite | 0 | 100 |
| Kalsilite | 0 | 40 |

The base systems are based explicitly on the respective constituting phases and not on the simple oxides.

In addition, the glass of the invention is to meet further conditions that are associated with the composition of constituting phases or the composition of simple oxides in formula relationships that are indicated further down.

Since both types of correlations—those relating to the composition specified in constituting phases and those relating to the composition specified in simple oxides—are used alongside one another, we will firstly give conversion matrices for the interconversion of the two types of composition figures.

Conversion from the Composition of Constituting Phases to Composition of Simple Oxides and Vice Versa

The composition of constituting phases is specified in a standardized form for the purpose of conversion, which reads as follows:

TABLE 3

| | Formula (normalized to |
|---|---|
| Constituting phase | a simple oxide) |
| Silicon dioxide | SiO₂ |
| Sodium sheet silicate | (3Na₂O•8SiO₂)/11 |
| Cordierite | (2MgO•2Al₂O₃•5SiO₂)/9 |
| Malinkoite | (Na₂O•B₂O₃•2SiO₂)/4 |
| Eucryptite | (Li₂O•Al₂O₃•2SiO₂)/4 |
| Nepheline | (Na₂O•Al₂O₃•2SiO₂)/4 |
| Kalsilite | (K₂O•Al₂O₃•2SiO₂)/4 |

The conversion of these compositions to a statement of composition in mol % based on the following simple oxides . . .

TABLE 4

| # | Oxide |
|---|---|
| 1. | SiO₂ |
| 2. | B₂O₃ |
| 3. | Al₂O₃ |
| 4. | MgO |
| 5. | Li₂O |
| 6. | Na₂O |
| 7. | K₂O |

. . . is done with the aid of the matrix specified here. This involves multiplying the matrix by the statement of composition in mol % with regard to the base glasses as column vector on the right:

TABLE 5
Matrix
$( \begin{matrix}1 & 8 / 11 & 5 / 9 & 2 / 4 & 2 / 4 & 2 / 4 & 2 / 4 \\ 0 & 0 & 0 & 1 / 4 & 0 & 0 & 0 \\ 0 & 0 & 2 / 9 & 0 & 1 / 4 & 1 / 4 & 1 / 4 \\ 0 & 0 & 2 / 9 & 0 & 0 & 0 & 0 \\ 0 & 0 & 0 & 0 & 1 / 4 & 0 & 0 \\ 0 & 3 / 11 & 0 & 1 / 4 & 0 & 1 / 4 & 0 \\ 0 & 0 & 0 & 0 & 0 & 0 & 1 / 4\end{matrix} ) \times ( \begin{matrix}{SiO}_{2} \\ ( 3 {Na}_{2} O \cdot 8 {SiO}_{2} ) / 11 \\ ( 2 MgO \cdot 2 {Al}_{2} {O}_{3} \cdot 5 {SiO}_{2} ) / 9 \\ ( {Na}_{2} O \cdot {B}_{2} {O}_{3} \cdot 2 {SiO}_{2} ) / 4 \\ ( {Li}_{2} O \cdot {Al}_{2} {O}_{3} \cdot 2 {SiO}_{2} ) / 4 \\ ( {Na}_{2} O \cdot {Al}_{2} {O}_{3} \cdot 2 {SiO}_{2} ) / 4 \\ ( {K}_{2} O \cdot {Al}_{2} {O}_{3} \cdot 2 {SiO}_{2} ) / 4\end{matrix} )$

The result obtained from the multiplication of the matrix by the column vector is the composition of the glass in mole percent.

Conversely, a composition in mole percent can be easily converted to a base glass composition via the respective inverse matrix. Of course, the only base glass compositions that are considered to be inventive are those that do not give negative values for the base glasses on conversion.

Importance of the Constituting Phases and the Selection Thereof with Regard to the Object of the Invention

The system of the constituting phases described herein enables the calculation of a multitude of properties of the glass. These properties cannot be inferred from the oxide composition on its own; the requirement for particular values of these properties is a second class of restrictions of the composition range defined by table 2.

The combination of table 2 with table 1 is itself a restriction with respect to table 1 in which the composition is specified in simple oxides. Within the composition space defined by table 1, the useful glass compositions are those which can be converted to the base system of the constituting phases without negative phase components and which obey both the limits defined in table 1 for the proportions of the simple oxides and the limits defined in table 2 or other tables for the proportions of the individual constituting phases (first class of restrictions).

The second class of restrictions includes that the values for the coefficient of thermal expansion and/or fracture resistance and/or hydrogen permeability that are calculated from the composition present in constituting phases satisfy the claimed requirements and/or that advantageous values also arise for one or more other calculated parameters.

With regard to the phases constituting the glass, the composition is chosen within the limits described here. The phases constituting the glass are of course not in crystalline form but in amorphous form in the glass product as such. But this does not mean that the constituting phases in the amorphous state have completely different assemblies that in the crystalline state. As stated above, the topology of the assemblies is comparable, i.e., for example, the coordination of the cations involved with surrounding oxygen atoms or the interatomic distance that arises from the coordination and the strength of the binding between these cations and surrounding oxygen atoms. Therefore, many properties of the glass of the invention can be well described using the constituting phases, especially in order to describe the inventive achievement and the problems overcome by the invention (in this regard see Conradt R., loc. cit.). The glass here may be produced of course not only using the corresponding crystals but also using the customary glass raw materials, provided that only the stoichiometric ratios enable the formation of the corresponding assemblies of the base glasses.

The phases are selected with regard to hydrogen permeability, density and the coefficient of thermal expansion and fracture resistance. Hydrogen permeability is assumed here to be dependent essentially on the packing density (the lower the packing density, the greater the hydrogen permeability) and the shear modulus G (according to the theory of Anderson and Stuart, the shear modulus is the crucial parameter for activation energy in the movement of an uncharged particle in a glass matrix; see O. L. Anderson, D. A. Stuart, Calculation of Activation Energy of Ionic Conductivity, Journal of The American Ceramic Society vol. 37, no. 12, pages 573-580, 1954).

Calculation methods are specified hereinafter, by which it is possible to calculate density, coefficient of thermal expansion, fracture resistance, packing density and shear modulus of a defined composition of constituting phases. These calculation methods are crucial both in the selection of the constituting phases and in the case of that composition of a glass of the invention from these constituting phases.

In the search for suitable calculation methods, it is found that, surprisingly, it is possible for the properties mentioned to find simple formulae from which indices or approximate values for these properties can be calculated, which in turn permit rapid classification of glass compositions into favorable or unfavorable with regard to the object of the invention.

### Density, Molar Volume and Packing Density

Remarkably, it is possible to calculate the density ρ in a very simple manner by lever rule from the molar masses Mᵢ and densities ρᵢ of the constituting phases:

$$ρ = \frac{{\sum }_{i = 1}^{n} {c}_{i} \cdot {M}_{i}}{{\sum }_{i = 1}^{n} {c}_{i} \frac{{M}_{i}}{{ρ}_{i}}} \qquad ( 1 )$$

The numerator of (1) is the molar mass, the denominator the molar volume Vₘₒₗ of the glass. It is thus possible to predict the density for the glass systems addressed here accurately to 1% on average. The density values listed below in table 6 can be found in A. Shyam, J. Muth, E. Lara-Curzio, Elastic properties of β-eucryptite in the glassy and microcracked crystalline states, Acta Materialia Volume 60, Issue 16, September 2012, Pages 5867-5876: eucryptite, Prüfberichte des akkreditierten Prüflabors der Schott AG [Test Reports from the Accredited Test Laboratory of Schott AG], Mainz, Germany: sodium sheet silicate, cordierite, N. H. Bansal, R. H. Doremus, Handbook of Glass Properties, Academic Press, Orlando, San Diego, New York, Austin, London, Montreal, Sydney, Tokyo, Toronto: Nepheline, O. V. Mazurin, M. V. Streltsina, T. P. Shvaiko-Shvaikovskaya, Handbook of Glass Data A-C, Elsevier, Amsterdam, 1983-1987: malinkoite, kalsilite (density value for kalsilite by extrapolation), Heraeus Quarzglas GmbH & Co. K G, Quarzstr. 8, 63450 Hanau, Germany, website, retrieved 9.12.2021, Quartz_lamp_materials_EN.pdf (heraeus.com): quartz glass.

We use the molar volume to calculate, as an intermediate parameter for further calculations, the packing density χ of the glass. For this purpose we first calculate the (molar) ionic volume for each constituting phase. We consider this to mean the volume that will be occupied by the to one mole of the constituting phase (specifically: one mole of the constituting phase normalized to a simple oxide) when they are regarded as spherical ions having what is called the “effective radius” by Robert Shannon; see Robert D. Shannon, Revised Effective Ionic Radii and Systematic Studies of Interatomic Distances in Halides and Chalcogenides, Acta Cryst. A32 (1976), p. 751-767. These radii differ according to the coordination number. For the cations, the necessary coordination numbers can be found in the mineralogical literature listed in the discussion of the constituting phases; according to Conradt R., loc. cit., we assume that the coordination numbers of the cations in the glass will be the same as those of the corresponding crystal phases. The oxygen atoms are assigned to the cations in accordance with valency, meaning that half an oxygen ion is assigned to a sodium ion etc. For the individual oxygen ion, it is then assumed that it is coordinated in accordance with this assignment, i.e. an oxygen ion assigned to a silicon ion is coordinated twice etc. If there are no explicit radius values for individual coordination numbers in the table from Robert D. Shannon, loc. cit., they are interpolated or extrapolated.

The resulting molar ionic volumes are tabulated below together with the molar masses and density values, and the packing density according to

$$χ = \frac{{\sum }_{i = 1}^{n} {c}_{i} \cdot {V}_{ion , i}}{{\sum }_{i = 1}^{n} {c}_{i} \frac{{M}_{i}}{{ρ}_{i}}} \qquad ( 2 )$$

TABLE 6
Molar masses, densities and molar ionic volumes
of the normalized constituting phases

| | Formula | | | Ionic | |
|---|---|---|---|---|---|
| Constituting | (normalized to | | ρᵢ/ | volume | Packing |
| phase | a simple oxide) | Mᵢ/g | (g/cm³) | V_{ion, i}/cm³ | density |
| Silicon dioxide | SiO₂ | 60.084 | 2.203 | 12.4589 | 0.4568 |
| Sodium sheet | (3Na₂O•8SiO₂)/11 | 60.6008 | 2.4458 | 12.5487 | 0.5070 |
| silicate | | | | | |
| Cordierite | (2MgO•2Al₂O₃•5SiO₂)/9 | 64.99444 | 2.628 | 12.9201 | 0.5224 |
| Nepheline | (Na₂O•Al₂O₃•2SiO₂)/4 | 71.027 | 2.498 | 14.6429 | 0.5149 |
| Eucryptite | (Li₂O•Al₂O₃•2SiO₂)/4 | 63.0025 | 2.46 | 13.0767 | 0.5105 |
| Malinkoite | (Na₂O•B₂O₃•2SiO₂)/4 | 62.9415 | 2.5447 | 15.0312 | 0.6077 |
| Kalsilite | (K₂O•Al₂O₃•2SiO₂)/4 | 79.081 | 2.551 | 17.92418 | 0.5781 |

With regard to the weight, the density of the glass calculated by formula (1) should preferably be not more than 2.70 g/cm³, further preferably not more than 2.65 g/cm³, even further preferably not more than 2.60 g/cm³. With regard to the packing density, which generally rises with density, the density of the glass calculated by formula (1) should preferably be, for example, at least 2.20 g/cm³, at least 2.25 g/cm³, or at least 2.30 g/cm³. The density of the glass calculated by formula (1) may, for example, be in a range from 2.20 to 2.70 g/cm³, from 2.25 to 2.65 g/cm³ or from 2.30 to 2.60 g/cm³.

The packing density χ of the glass calculated by formula (2), with regard to the hydrogen permeability that falls with rising packing density, may, for example, be at least 0.49, at least 0.50, at least 0.51, or at least 0.52. With regard to the crystallization tendency that generally rises with rising packing density, the packing density χ of the glass calculated by formula (2) should preferably, for example, be at most 0.62, at most 0.61, at most 0.60, at most 0.59, at most 0.58, or at most 0.57. The packing density χ of the glass calculated by formula (2) may, for example, be in a range from 0.49 to 0.62, from 0.49 to 0.61, from 0.49 to 0.60, from 0.50 to 0.59, from 0.51 to 0.58, or from 0.52 to 0.57.

### Coefficient of Thermal Expansion

Remarkably, the coefficient of thermal expansion (CTE) can likewise be calculated by a simple lever rule. For this purpose, the coefficients of thermal expansion of the constituting phases CTEᵢ are weighted by their proportions by volume and the compression moduli Kᵢ and added up; see the below formula (3), which is identical to formula (12) in C. P. Wong, R. S. Bollampally, Thermal Conductivity, Elastic Modulus, and Coefficient of Thermal Expansion of Polymer Composites Filled with Ceramic Particles for Electronic Packaging, School of Materials Science and Engineering, Georgia Institute of Technology, Atlanta, Georgia 30332, downloaded from academia.edu on 9.12.2021, (PDF) Thermal Conductivity, Elastic Modulus, and Coefficient of Thermal Expansion of Polymer Composites Filled with Ceramic Particles for Electronic Packaging [symbol] -Academia.edu. The proportions by volume of the constituting phases in turn are calculated directly from the molar volumes of the constituting phases and the molar proportion thereof.

$$CTE = \frac{{\sum }_{i = 1}^{n} {c}_{i} \frac{{M}_{i}}{{ρ}_{i}} {K}_{i} \cdot {CTE}_{i}}{{\sum }_{i = 1}^{n} {c}_{i} \frac{{M}_{i}}{{ρ}_{i}} {K}_{i}} \qquad ( 3 )$$

The CTEᵢ values can be found in the following table:

TABLE 7
Molar masses, densities and molar ionic volumes
of the normalized constituting phases

| | Formula (normalized to | |
|---|---|---|
| Constituting phase | a simple oxide) | CTEᵢ |
| Silicon dioxide | SiO2 | 0.6 |
| Sodium sheet silicate | (3Na₂O•8SiO₂)/11 | 13.19 |
| Cordierite | (2MgO•2Al₂O₃•5SiO₂)/9 | 3.56 |
| Nepheline | (Na₂O•Al₂O₃•2SiO₂)/4 | 10.8 |
| Eucryptite | (Li₂O•Al₂O₃•2SiO₂)/4 | 7.8 |
| Malinkoite | (Na₂O•B₂O₃•2SiO₂)/4 | 10.7 |
| Kalsilite | (K₂O•Al₂O₃•2SiO₂)/4 | 11.8 |

The values come from: Prüfberichte des akkreditierten Prüflabors der Schott AG, Mainz, Germany: sodium sheet silicate, cordierite, nepheline, N. H. Bansal, R. H. Doremus, Handbook of Glass Properties, Academic Press, Orlando, San Diego, New York, Austin, London, Montreal, Sydney, Tokyo, Toronto: eucryptite, malinkoite (the latter by extrapolation), Heraeus Quarzglas GmbH & Co. KG, Quarzstr. 8, 63450 Hanau, Germany, website, retrieved 9.12.2021, Quartz_lamp_materials_EN.pdf (heraeus.com): quartz glass. The value for kalsilite has been found by extrapolation of the values for eucryptite and nepheline. It is known from the literature that the coefficient of thermal expansion for metals, for example, is inversely proportional to the binding energy (or to the “depth of the interatomic potential wells”); see, for example, H. Föll, lecture handout “Einführung in die Materialwissenschaft I” [Introduction into Material Science I], Christian Albrechts-Universität Kiel, pages 79-83. Therefore, the CTE of kalsilite is obtained when the CTEs of eucryptite and nepheline are plotted against the average bond strength (or “average potential well depth”; see the remarks that follow with regard to modulus of elasticity) for each cation against the average binding energy per cation, and the line drawn through these points is continued to the average binding energy per cation.

The compression modulus K and the shear modulus G, which is required below and is therefore also reported here, are calculated from the modulus of elasticity E (see the remarks further down with regard to the calculation of modulus of elasticity E by formula (8)), and Poisson's value μ (see the remarks further down with regard to the calculation of Poisson's value μ by formula (9)), as follows:

$$G = \frac{E}{2 ( 1 + μ )} \qquad ( 4 a )$$

$$K = \frac{E}{3 ( 1 - 2 μ )} \qquad ( 4 b )$$

See, for example, H. Föll, lecture handout “Einführung in die Materialwissenschaft I”, Christian Albrechts-Universität Kiel, pages 79-83.

Since the CTE of carbon fibers is −0.1 ppm/K in longitudinal direction and 10 ppm/K in transverse direction, the CTE of the glass of the invention is preferably 3.5-9.5 ppm/K, more preferably 5-8 ppm/K.

The CTE of the glass calculated by formula (3) is, for example, at least 3.5 ppm/K, at least 4.0 ppm/K, at least 4.5 ppm/K, or at least 5.0 ppm/K. The CTE of the glass calculated by formula (3) is, for example, at most 9.5 ppm/K, at most 9.0 ppm/K, at most 8.5 ppm/K, or at most 8.0 ppm/K. The CTE of the glass calculated by formula (3) may, for example, be in a range from 3.5 to 9.5 ppm/K, from 4.0 to 9.0 ppm/K, from 4.5 to 8.5 ppm/K, or from 5.0 to 8.0 ppm/K.

Also of significance is the ratio of the coefficients of thermal expansion of the glass compared to the reinforcing material. The difference between the CTE of the reinforcing material and the CTE of the glass calculated by formula (3) is preferably in a range from 0.0 to 10.0 ppm/K, from 0.1 to 7.5 ppm/K, from 0.2 to 5.0 ppm/K, from 0.5 to 2.5 ppm/K, or from 1.0 to 2.0 ppm/K. The difference between the CTE of the reinforcing material and of the CTE of the glass calculated by formula (3) is preferably at most 10.0 ppm/K, at most 7.5 ppm/K, at most 5.0 ppm/K, at most 2.5 ppm/K, or at most 2.0 ppm/K. The difference between the CTE of the reinforcing material and the CTE of the glass calculated by formula (3) may, for example, be about 0.0 ppm/K, at least 0.1 ppm/K, at least 0.2 ppm/K, at least 0.5 ppm/K, or at least 1.0 ppm/K. “Difference” is understood in particular to mean the difference between the CTE of the reinforcing material and the CTE of the glass calculated by formula (3) or the magnitude of that difference.

The difference between the CTE of the reinforcing material in transverse direction and the CTE of the glass calculated by formula (3) is preferably in a range from 0.0 to 10.0 ppm/K, from 0.1 to 7.5 ppm/K, from 0.2 to 5.0 ppm/K, from 0.5 to 2.5 ppm/K, or from 1.0 to 2.0 ppm/K. The difference between the CTE of the reinforcing material in transverse direction and the CTE of the glass calculated by formula (3) is preferably at most 10.0 ppm/K, at most 7.5 ppm/K, at most 5.0 ppm/K, at most 2.5 ppm/K, or at most 2.0 ppm/K. The difference between the CTE of the reinforcing material in transverse direction and the CTE of the glass calculated by formula (3) may, for example, be about 0.0 ppm/K, at least 0.1 ppm/K, at least 0.2 ppm/K, at least 0.5 ppm/K, or at least 1.0 ppm/K. “Difference” is understood in particular to mean the difference between the CTE of the reinforcing material in transverse direction and the CTE of the glass calculated by formula (3) or the magnitude of that difference.

The difference between the CTE of the glass calculated by formula (3) and the CTE of the reinforcing material in longitudinal direction is preferably in a range from 1.0 to 12.5 ppm/K, from 2.5 to 10.0 ppm/K or from 5.0 to 7.5 ppm/K. The difference between the CTE of the glass calculated by formula (3) and the CTE of the reinforcing material in longitudinal direction may, for example, be at least 1.0 ppm/K, at least 2.5 ppm/K or at least 5.0 ppm/K. The difference between the CTE of the glass calculated by formula (3) and the CTE of the reinforcing material in longitudinal direction may, for example, be at most 12.5 ppm/K, at most 10.0 ppm/K or at most 7.5 ppm/K. “Difference” is understood in particular to mean the difference between the CTE of the glass calculated by formula (3) and the CTE of the reinforcing material in longitudinal direction or the magnitude of that difference.

### Modulus of Elasticity

The starting point for the calculation of the modulus of elasticity is the theory of Makishima and Mackenzie; see “Direct calculation of Young's modulus of glass”, “Calculation of bulk modulus, shear modulus and Poisson's ratio of glass”, J. Non-Crystall. Sol., 1973 and 1975.

We first require an expression for the dissociation energy per unit volume, which we calculate from the average bond strength and the molar volume.

In a simple picture of oxidic glasses, the cations are placed in a respective potential well formed by the surrounding oxygen atoms, and the depth of said potential well is assumed to be the sum total of the bond strengths of the different single bonds to the surrounding oxygen atoms; in other words, the whole interaction energy is concentrated in potential wells with the cations at the center and the oxygen atoms in the periphery. It is thus no longer necessary to consider the reverse case; it would also be more difficult to analyze since an oxygen atom can be present between multiple different kinds of cations, which cannot occur conversely in purely oxidic glasses. These values are tabulated, for example, in DE 10 2014 119 594 A1:

TABLE 8

| Cation | Potential well depth/(kJ/mol) |
|---|---|
| Si | 1864 |
| B | 1572.5 |
| Al | 1537 |
| Mg | 999 |
| Li | 585 |
| Na | 440.5 |
| K | 395 |

An average potential well depth or average bond strength per cation can be calculated from the composition of a glass from the above-specified constituting phases, the numbers of different cations present in the respective phases and the above-tabulated potential well depths per cation:

$$\overline{{E}_{pot}} = \frac{{\sum }_{i = 1}^{n} {c}_{i} \cdot {\sum }_{j = 1}^{m} {z}_{i , j} \cdot {E}_{pot , i}}{{\sum }_{i = 1}^{n} {c}_{i} \cdot {\sum }_{j = 1}^{m} {z}_{i , j}} , \qquad ( 5 )$$

The number z of cations per molecule is:

$$z = \frac{{\sum }_{i = 1}^{n} {c}_{i} \cdot {\sum }_{j = 1}^{m} {z}_{i , j}}{{\sum }_{i = 1}^{n} {c}_{i}} , \qquad ( 6 )$$

In this formula, m is the number of cation types that occur, E_{pot,j} is the above-tabulated potential well depth for the jth cation type and z_{j,i} is the number of cations of the jth type in the ith constituting phase, and cᵢ (as in all formulae used herein) is the molar proportion of the ith constituting phase.

The sums over j are tabulated in the following table:

TABLE 9

| Constituting phase | Formula (normalized to a simple oxide) | ${\sum }_{j = 1}^{m} {z}_{i , j}$ | ${\sum }_{j = 1}^{m} {z}_{i , j} \cdot {E}_{pot , j} / ( kJ / mol )$ |
|---|---|---|---|
| Silicon dioxide | SiO₂ | 1 | 1864 |
| Sodium sheet silicate | (3Na₂O · 8SiO₂)/11 | 1 | 1595.909 |
| Cordierite | (2MgO · 2Al₂O₃ · 5SiO₂)/9 | 1.2222 | 1940.6666 |
| Nepheline | (Na₂O · Al₂O₃ · 2SiO₂)/4 | 1.5 | 1920.75 |
| Eucryptite | (Li₂O · Al₂O₃ · 2SiO₂)/4 | 1.5 | 1993 |
| Malinkoite | (Na₂O · B₂O₃ · 2SiO₂)/4 | 1.5 | 1938.5 |
| Kalsilite | (K₂O · Al₂O₃ · 2SiO₂)/4 | 1.5 | 1898 |

The product of average potential well depth per cation and the number of cations is then the dissociation energy per mole being sought.

As in Makishima and Mackenzie, a linear correlation between modulus of elasticity and dissociation energy density is then assumed:

$$E ∝ \frac{\overline{{E}_{pot}} \cdot z}{{V}_{mot}} \qquad ( 7 )$$

The evaluation of a number of different silicatic glasses of different types, but without such an excess of boron over the alkali metal and alkaline earth metal oxides minus aluminum oxide, leads to the following formula:

$$E = ( 1.745 \cdot ( \frac{\overline{{E}_{pot}} \cdot z}{{V}_{mot}} ) - 45.369 ) GP α \qquad ( 8 )$$

In this formula, E̅ₚ̅ₒ̅ₜ̅ should be determined in kJ/mol, z dimensionlessly (mole of cations per mole of glass) and Vₘₒₗ in cm³. E̅ₚ̅ₒ̅ₜ̅ should in each case be determined according to equation (5) and table 9. z should in each case be determined according to equation (6) and table 9. Vₘₒₗ is the denominator in equation (1). In this way, an average error of 2 GPa is obtained in the calculation of E.

For a hydrogen barrier material, it is advantageous with regard to the correlation with fracture resistance described below to combine a low hydrogen permeability with a high modulus of elasticity in order to achieve high fracture resistance. The modulus of elasticity E calculated by formula (8) may, for example, be at least 60 GPa, at least 65 GPa, at least 70 GPa at least 75 GPa, at least 80 GPa, at least 85 GPa, or at least 90 GPa. The modulus of elasticity E calculated by formula (8) may, for example, be at most 95 GPa, at most 94 GPa, at most 93 GPa, at most 92 GPa or at most 91 GPa. The modulus of elasticity E calculated by formula (8) may, for example, be in a range from 60 to 95 GPa, from 65 to 94 GPa, from 70 to 94 GPa, from 75 to 93 GPa, from 80 to 92 GPa, from 85 to 92 GPa or from 90 to 91 GPa.

### Poisson's Value

The examination of a series of glasses in the range of the invention showed that Poisson's value μ depends on packing density, to the following degree found empirically:

$$μ = 0.5818 \cdot χ - 0.0793 \qquad ( 9 )$$

The calculation of Poisson's value by formula (9) maps the abovementioned preferred ranges for packing density directly into corresponding ranges for Poisson's value.

### Hydrogen Permeability

The examination of a series of glasses showed that, as stated above, hydrogen permeability p depends on packing density χ and shear modulus G, to the following degree found empirically:

$$lg ( \frac{p}{mol / m \cdot s \cdot Pa} ) = - 44.525 \cdot {( \frac{G}{GP α} )}^{0.1} \cdot {χ}^{0.9} + 14.203 \qquad ( 10 )$$

The numerical value of the specified decadic algorithm is preferably <−19.500, more preferably <−20.000, <−20.100, <−20.200, <−20.300, or <−20.400, even more preferably <−20.500, <−20.600, <−20.700, <−20.800, or <−20.900, even further preferably <−21.000, or <−21.250, even further preferably <−21.500, or <−21.750, even further preferably <−22.000, or <−22.250, even further preferably <−22.500, or <−22.750, even further preferably <−23.000, or <−23.250, even further preferably <−23.500, or <−23.750, most preferably <−24.000. The decadic logarithm of hydrogen permeability p calculated by formula (10) may, for example, be more than −29.000, more than −28.500, more than −28.000, more than −27.500, more than −27.000, more than −26.500, more than −26.000, more than −25.500, more than −25.000, or more than −24.500. The decadic logarithm of hydrogen permeability p calculated by formula (10) may, for example, be in a range from more than −29.000 to less than −20.000, from more than −29.000 to less than −20.100, from more than −29.000 to less than −20.200, from more than −29.000 to less than −20.300, from more than −29.000 to less than −20.400, from more than −29.000 to less than −20.500, from more than −29.000 to less than −20.600, from more than −29.000 to less than −20.700, from more than −29.000 to less than −20.800, from more than −29.000 to less than −20.900, from more than −29.000 to less than −21.000, from more than −29.000 to less than −21.250, from more than −29.000 to less than −21.500, from more than −29.000 to less than −21.750, from more than −28.500 to less than −22.000, from more than −28.000 to less than −22.250, from more than −27.500 to less than −22.500, from more than −27.000 to less than −22.750, from more than −26.500 to less than −23.000, from more than −26.000 to less than −23.250, from more than −25.500 to less than −23.500, from more than −25.000 to less than −23.750, or from more than −24.500 to less than −24.000.

In formula (10), G describes the shear modulus calculated by formula (4a), and X the packing density calculated by formula (2). In formula (10), hydrogen permeability p especially denotes hydrogen permeability at a temperature of 473 K.

### Fracture Resistance K_{1c}

The K_{1c} means the value measured by the SEPB method for which the NIST found a correlation with the modulus of elasticity; see George D. Quinn, Jeffrey J. Swab, Fracture toughness of glasses as measured by the SCF and SEPB methods, Journal of the European Ceramic Society 37 (2017) 4243-4257.

The comparison of K_{1c} values measured in the accredited test laboratory at Schott AG, Mainz, Germany, by the SEPB method on a series of alumino- and borosilicates, quartz glass, and binary silicates with the values for moduli of elasticity (E_{calculated}) calculated according to (4, 8, 9) leads to the formula:

$${K}_{1 c} = 0 \text{.0147} \cdot {E}_{calculated} - 0.3503 \qquad ( 11 )$$

The K_{1c} calculated by formula (11) is preferably at least 0.80 MPa·√m, more preferably at least 0.85 MPa·√m, even more preferably at least 0.90 MPa·√m, even further preferably at least 0.95 MPa·√m, most preferably at least 1.00 MPa·√m. The K_{1c} calculated by formula (11) may, for example, be at most 1.05 MPa·√m, at most 1.04 MPa·√m, at most 1.03 MPa·√m, at most 1.02 MPa·√m or at most 1.01 MPa·√m. The K_{1c} calculated by formula (11) may, for example, be in a range from 0.80 to 1.05 MPa·√m, from 0.85 to 1.04 MPa·√m, from 0.90 to 1.03 MPa·√m, from 0.95 to 1.02 MPa·√m or from 1.00 to 1.01 MPa·√m.

### Selection of Suitable Constituting Phases

### Silicon Dioxide

The crystal lattice of crystalline SiO₂ consists of three-dimensionally crosslinked SiO₄ tetrahedra. Silica glass, i.e. pure SiO₂, likewise has a three-dimensional network structure having a mesh size, the radius of which is about 0.6 Å; see O. L. Anderson, D. A. Stuart, Calculation of Activation Energy of Ionic Conductivity, Journal of The American Ceramic Society vol. 37, no. 12, pages 573-580, 1954. (The mesh diameter is thus about 1.2 Å.) The H₂ molecule has a radius of about 1.2 Å; see O. L. Anderson, D. A. Stuart, loc. cit. Silica glass is thus suitable in principle as hydrogen barrier material.

The above-defined key values for SiO₂ are:

| | |
|---|---|
| Measured density/(g/cm³) | 2.203 |
| Measured coefficient of thermal expansion/(ppm/K) | 0.6 |
| Packing density according to (2) | 0.456811353 |
| Shear modulus according to (4, 8, 9)/GPa | 31.14 |
| Compression modulus according to (4, 8, 9)/GPa | 39.28 |
| Modulus of elasticity according to (4, 8, 9)/GPa | 73.89 |
| K_{1c} according to (11) | 0.74 |
| Ig(hydrogen permeability/ | −16.82 |
| (mol/(m · s · Pa))) according to (10) | |

The hydrogen permeability is much greater than that of the constituting phases that follow, but these all have high coefficients of thermal expansion. SiO₂ is therefore incorporated in the glass of the invention particularly with regard to the adjustment of the coefficient of thermal expansion to the desired value.

Calculated modulus of elasticity and fracture resistance are in the moderate range.

The proportion of the constituting phase silicon dioxide may, for example, be in a range from 0.0 to 50 mol %, from 1.0 to 45 mol %, from 2.0 to 40 mol %, from 4.0 to 35 mol %, from 6.0 to 30 mol %, from 8.0 to 25 mol %, or from 10 to 20 mol %. The proportion of the constituting phase silicon dioxide may, for example, be at least 1.0 mol %, at least 2.0 mol %, at least 4.0 mol %, at least 6.0 mol %, at least 8.0 mol %, at least 10 mol %, at least 15 mol %, or at least 20 mol %. The proportion of the constituting phase silicon dioxide may, for example, be at most 50 mol %, at most 45 mol %, at most 40 mol %, at most 35 mol %, at most 30 mol %, at most 25 mol %, at most 20 mol %, at most 15 mol %, at most 10 mol %, at most 5.0 mol %, at most 2.0 mol %, or at most 1.0 mol %. The glass may also be free of the constituting phase silicon dioxide.

### Sodium Sheet Silicate

Because of its higher packing density, sodium sheet silicate (3Na₂O·8SiO₂)/11 has a lower hydrogen permeability than SiO₂.

The above-defined key values for (3Na₂O·8SiO₂)/11 are:

| | |
|---|---|
| Measured density/(g/cm³) | 2.4486 |
| Measured coefficient of thermal expansion/(ppm/K) | 13.19 |
| Packing density according to (2) | 0.507037043 |
| Shear modulus according to (4, 8, 9)/GPa | 27.63 |
| Compression modulus according to (4, 8, 9)/GPa | 39.39 |
| Modulus of elasticity according to (4, 8, 9)/GPa | 67.18 |
| K_{1c} according to (11) | 0.64 |
| Ig(hydrogen permeability/ | −19.47 |
| (mol/(m · s · Pa))) according to (10) | |

The coefficient of thermal expansion is high, and so this constituting phase is also only suitable as an addition.

Calculated modulus of elasticity and fracture resistance are in the lower range.

The proportion of sodium sheet silicate may, for example, be in a range from 0.0 to 50 mol %, from 1.0 to 45 mol %, from 2.0 to 40 mol %, from 5.0 to 35 mol %, from 10 to 30 mol % from 20 to 25 mol %. The proportion of sodium sheet silicate may, for example, be at least 1.0 mol %, at least 2.0 mol %, at least 5.0 mol %, at least 10 mol %, at least 15 mol %, at least 20 mol %, at least 25 mol %, or at least 30 mol %. The proportion of sodium sheet silicate may, for example, be at most 50 mol %, at most 45 mol %, at most 40 mol %, at most 35 mol %, at most 30 mol %, at most 25 mol %, at most 20 mol %, at most 15 mol %, at most 10 mol %, at most 8.0 mol %, at most 6.0 mol %, at most 5.0 mol %, at most 4.0 mol %, at most 2.0 mol %, or at most 1.0 mol %. The glass may also be free of sodium sheet silicate.

### Nepheline

In order to achieve an even higher hydrogen barrier function than with SiO₂, it is possible to move to what are called “plugged structures”. These are crystals or glasses wherein the base skeleton, as in the case of SiO₂, is a three-dimensionally crosslinked tetrahedral network in which, however, alkali metal or alkaline earth metal ions are intercalated into some of the meshes, which firstly additionally prevent hydrogen transport and secondly constitute a kind of dispersion stiffening, and therefore increase the elastic modulus. A suitable system is nepheline, which consists of three-dimensionally crosslinked SiO₄ and AlO₄ tetrahedra, with sodium ions incorporated into the meshes. One mole of nepheline is understood in accordance with the invention to mean one mole of (Na₂O·Al₂O₃·2SiO₂)/4.

The above-defined key values for nepheline are:

| | |
|---|---|
| Measured density/(g/cm³) | 2.498 |
| Measured coefficient of thermal expansion/(ppm/K) | 10.8 |
| Packing density according to (2) | 0.5149 |
| Shear modulus according to (4, 8, 9)/GPa | 29.70 |
| Compression modulus according to (4, 8, 9)/GPa | 43.20 |
| Modulus of elasticity according to (4, 8, 9)/GPa | 72.49 |
| K_{1c} according to (11) | 0.72 |
| Ig(hydrogen permeability/ | −20.19 |
| (mol/(m · s · Pa))) according to (10) | |

With regard to the abovementioned values, nepheline is suitable as a “base phase” for a hydrogen barrier glass, into which, however, SiO₂ has to be mixed with regard to thermal expansion, for example.

Calculated modulus of elasticity and fracture resistance are in the moderate range.

The proportion of nepheline may, for example, be in a range from 0.0 to 100 mol %, from 1.0 to 90 mol %, from 2.0 to 80 mol %, from 5.0 to 70 mol %, from 10 to 60 mol %, from 20 to 50 mol %, or from 30 to 40 mol %. The proportion of nepheline may, for example, be at least 1.0 mol %, at least 2.0 mol %, at least 5.0 mol %, at least 10 mol %, at least 15 mol %, at least 20 mol %, at least 25 mol %, or at least 30 mol %. The proportion of nepheline may, for example, be at most 90 mol %, at most 80 mol %, at most 70 mol %, at most 60 mol %, at most 50 mol %, at most 40 mol %, at most 35 mol %, at most 30 mol %, at most 25 mol %, at most 20 mol %, at most 15 mol %, at most 10 mol %, at most 5.0 mol %, at most 2.0 mol %, or at most 1.0 mol %. The glass may also be free of nepheline.

### Eucryptite

By comparison with nepheline, eucryptite brings another considerable increase in modulus of elasticity, which results in turn in a lower hydrogen permeability. According to the invention, one mole of eucryptite means one mole of (Li₂O·Al₂O₃·2SiO₂)/4.

The above-defined key values for eucryptite are:

| | |
|---|---|
| Measured density/(g/cm³) | 2.46 |
| Measured coefficient of thermal expansion/(ppm/K) | 7.8 |
| Packing density according to (2) | 0.5106 |
| Shear modulus according to (4, 8, 9)/GPa | 37.11 |
| Compression modulus according to (4, 8, 9)/GPa | 53.38 |
| Modulus of elasticity according to (4, 8, 9)/GPa | 90.38 |
| K_{1c} according to (11) | 0.98 |
| Ig(hydrogen permeability/ | −20.69 |
| (mol/(m · s · Pa))) according to (10) | |

With regard to these values, eucryptite is of even better suitability as base phase for a hydrogen barrier material than nepheline. Because of its smaller coefficient of expansion, the addition of SiO₂ may be smaller in order to achieve a coefficient of expansion comparable to the average coefficient of expansion of carbon fibers. This is in turn beneficial to the hydrogen barrier effect. Calculated modulus of elasticity and fracture resistance are in the upper range. A disadvantage is the cost of the lithium oxide component.

The proportion of eucryptite may, for example, be in a range from 0.0 to 100 mol %, from 1.0 to 90 mol %, from 2.0 to 80 mol %, from 5.0 to 70 mol %, from 10 to 60 mol % from 20 to 50 mol %, or from 30 to 40 mol %. The proportion of eucryptite may, for example, be at least 1.0 mol %, at least 2.0 mol %, at least 5.0 mol %, at least 10 mol %, at least 15 mol %, at least 20 mol %, at least 25 mol %, at least 30 mol %, at least 40 mol %, at least 50 mol %, or at least 60 mol %. The proportion of eucryptite may, for example, be at most 90 mol %, at most 80 mol %, at most 70 mol %, at most 60 mol %, at most 50 mol %, at most 40 mol %, at most 35 mol %, at most 30 mol %, at most 25 mol %, at most 20 mol %, at most 15 mol %, at most 10 mol %, at most 5.0 mol %, at most 2.0 mol %, or at most 1.0 mol %. The glass may also be free of eucryptite.

### Cordierite

According to the invention, one mole of cordierite means one mole of (2MgO·2Al₂O₃·5SiO₂)/9.

The above-defined key values for cordierite are:

| | |
|---|---|
| Measured density/(g/cm³) | 2.628 |
| Measured coefficient of thermal expansion/(ppm/K) | 3.56 |
| Packing density according to (2) | 0.5224 |
| Shear modulus according to (4, 8, 9)/GPa | 37.39 |
| Compression modulus according to (4, 8, 9)/GPa | 55.44 |
| Modulus of elasticity according to (4, 8, 9)/GPa | 91.58 |
| K_{1c} according to (11) | 1.00 |
| Ig(hydrogen permeability/ | −21.45 |
| (mol/(m · s · Pa))) according to (10) | |

With regard to the low coefficient of expansion and low hydrogen permeability, cordierite is an excellent base phase for a hydrogen barrier material. For attainment of the desired coefficient of expansion, constituting phases such as nepheline or eucryptite must be added, which are themselves very good barrier materials.

Calculated modulus of elasticity and fracture resistance are in the upper range.

The proportion of cordierite may, for example, be in a range from 0.0 to 100 mol %, from 1.0 to 90 mol %, from 2.0 to 80 mol %, from 5.0 to 70 mol %, from 10 to 60 mol % from 20 to 50 mol %, or from 30 to 40 mol %. The proportion of cordierite may, for example, be at least 1.0 mol %, at least 2.0 mol %, at least 5.0 mol %, at least 10 mol %, at least 15 mol %, at least 20 mol %, at least 25 mol %, at least 30 mol %, at least 40 mol %, at least 50 mol %, or at least 60 mol %. The proportion of cordierite may, for example, be at most 90 mol %, at most 80 mol %, at most 75 mol %, at most 70 mol %, at most 60 mol %, at most 50 mol %, at most 40 mol %, at most 35 mol %, at most 30 mol %, at most 25 mol %, at most 20 mol %, at most 15 mol %, at most 10 mol %, at most 5.0 mol %, at most 2.0 mol %, or at most 1.0 mol %. The glass may also be free of cordierite.

### Malinkoite

According to the invention, one mole of malinkoite means one mole of (Na₂O·B₂O₃·2SiO₂)/4.

The above-defined key values for malinkoite are:

| | |
|---|---|
| Measured density/(g/cm³) | 2.5477 |
| Measured coefficient of thermal expansion/(ppm/K) | 10.7 |
| Packing density according to (2) | 0.6077 |
| Shear modulus according to (4, 8, 9)/GPa | 35.86 |
| Compression modulus according to (4, 8, 9)/GPa | 67.48 |
| Modulus of elasticity according to (4, 8, 9)/GPa | 91.39 |
| K_{1c} according to (11) | 0.99 |
| Ig(hydrogen permeability/ | −26.47 |
| (mol/(m · s · Pa))) according to (10) | |

With regard to the very low hydrogen permeability, malinkoite is a very good added component for a hydrogen barrier material. In order to achieve the desired coefficient of expansion, however, it is necessary to proceed for example from a base glass such as cordierite.

By comparison with the aluminum analog of malinkoite, namely nepheline, hydrogen permeability is very low in the case of malinkoite. Analogous systems having respectively tetrahedrally coordinated boron or aluminum are thus notable for stiffer bonding angles in the boron-containing analog, shorter bond distances and lower compressibility than in the aluminum-containing analog. All these differences have an inhibiting effect on the diffusion of hydrogen. From this point of view, malinkoite is therefore a particularly preferred constituting phase.

Calculated modulus of elasticity and fracture resistance are in the upper range.

The proportion of malinkoite may, for example, be in a range from 0.0 to 100 mol %, from 1.0 to 90 mol %, from 2.0 to 80 mol %, from 5.0 to 70 mol %, from 10 to 60 mol %, from 20 to 50 mol %, or from 30 to 40 mol %. The proportion of malinkoite may, for example, be at least 1.0 mol %, at least 2.0 mol %, at least 5.0 mol %, at least 10 mol %, at least 15 mol %, at least 20 mol %, at least 25 mol %, at least 30 mol %, at least 40 mol %, at least 50 mol %, or at least 60 mol %. The proportion of malinkoite may, for example, be at most 90 mol %, at most 80 mol %, at most 75 mol %, at most 70 mol %, at most 60 mol %, at most 50 mol %, at most 40 mol %, at most 35 mol %, at most 30 mol %, at most 25 mol %, at most 20 mol %, at most 15 mol %, at most 10 mol %, at most 5.0 mol %, at most 2.0 mol %, or at most 1.0 mol %. The glass may also be free of malinkoite.

### Cordierite and Malinkoite

Also of particular significance are the sum total of the molar proportions of cordierite and malinkoite, and the ratio of the molar proportion of cordierite to the molar proportion of malinkoite. Cordierite and malinkoite are those constituting phases that combine a high modulus of elasticity and hence high fracture resistance with very low hydrogen permeability. Therefore, the sum total thereof preferably has a high proportion.

The sum total of the molar proportions of cordierite and malinkoite is preferably in a range from 50 to 100 mol %, for example from 60 to 90 mol % or from 70 to 80 mol %. The sum total of the molar proportions of cordierite and malinkoite is preferably at least 50 mol %, for example at least 60 mol % or at least 70 mol %. The sum total of the molar proportions of cordierite and malinkoite may, for example, be at most 90 mol % or at most 80 mol %.

The molar proportion of cordierite is preferably at least as high as the molar proportion of malinkoite. The molar proportion of cordierite is preferably greater than the molar proportion of malinkoite. The difference between the molar proportion of cordierite and the molar proportion of malinkoite is preferably in a range from 0 to 40 mol %, for example from 10 to 30 mol %. The molar proportion of cordierite may exceed the molar proportion of malinkoite, for example, by at least 10 mol % or by at least 20 mol %. The ratio of the molar proportion of cordierite to the molar proportion of malinkoite is preferably in a range from 0.5 to 5.0, preferably from 1.0 to 4.0, from 1.3 to 3.0, from 1.5 to 2.5 or from 1.6 to 2.0. The ratio of the molar proportion of cordierite to the molar proportion of malinkoite is preferably at least 0.5, further preferably at least 1.0, for example at least 1.3, at least 1.5 or at least 1.6. The ratio of the molar proportion of cordierite to the molar proportion of malinkoite is preferably at most 5.0, further preferably at most 4.0, for example at most 3.0, at most 2.5 or at most 2.0. Since cordierite has a coefficient of thermal expansion of 3.56 ppm/K and malinkoite a coefficient of thermal expansion of 10.7 ppm/K, the ratios of the molar proportions mentioned are particularly preferred for adjustment of the coefficient of thermal expansion of the barrier material to the coefficient of thermal expansion of the reinforcing material, especially to the average coefficient of thermal expansion of carbon fibers.

### Kalsilite

According to the invention, one mole of kalsilite means one mole of (K₂O·Al₂O₃·2SiO₂)/4.

The above-defined key values for kalsilite are:

| | |
|---|---|
| Measured density/(g/cm³) | 2.551 |
| Measured coefficient of thermal expansion/(ppm/K) | 10.9 |
| Packing density according to (2) | 0.5782 |
| Shear modulus according to (4, 8, 9)/GPa | 24.46 |
| Compression modulus according to (4, 8, 9)/GPa | 42.19 |
| Modulus of elasticity according to (4, 8, 9)/GPa | 61.50 |
| K_{1c} according to (11) | 0.55 |
| Ig(hydrogen permeability/ | −23.23 |
| (mol/(m · s · Pa))) according to (10) | |

With regard to low hydrogen permeability, kalsilite is a good base glass addition for a hydrogen barrier material. The simultaneously low modulus of elasticity distinguishes kalsilite from all other constituting phases having very low hydrogen permeability, which is advantageous for the flexibility of a later component. With regard to thermal expansion, it is also possible to add SiO₂ for example. Like all aluminosilicates, it is additionally a glass of low brittleness. Calculated modulus of elasticity and fracture toughness are in the lower range.

The proportion of kalsilite may, for example, be in a range from 0.0 to 40 mol %, from 1.0 to 35 mol %, from 2.0 to 30 mol %, from 5.0 to 25 mol %, or from 10 to 20 mol %. The proportion of kalsilite may, for example, be at least 1.0 mol %, at least 2.0 mol %, at least 5.0 mol %, at least 10 mol %, at least 15 mol %, or at least 20 mol %. The proportion of kalsilite may, for example, be at most 40 mol %, at most 35 mol %, at most 30 mol %, at most 25 mol %, at most 20 mol %, at most 15 mol %, at most 10 mol %, at most 5.0 mol %, at most 2.0 mol %, or at most 1.0 mol %. The glass may also be free of kalsilite.

### Further Components

In addition to the components already mentioned, the glass may contain further constituents that are referred to herein as “residue”. The proportion of the residue in the glass of the invention is preferably at most 3.0 mol %, in order not to disrupt the glass properties established by careful selection of suitable base glasses. In particular, the content of individual oxides is preferably limited to <0.5 mol %. In particularly preferred embodiments, the proportion of residue in the glass is at most 2.0 mol %, more preferably at most 1.0 mol % or at most 0.5 mol %. The residue in particular contains oxides that are not included in the base glasses mentioned here. The residue thus in particular does not contain any SiO₂, Al₂O₃, B₂O₃, Na₂O, Li₂O, K₂O, MgO. In some embodiments, the glass is free of any residue. This means that the glass contains essentially only those oxides attributable to the constituting phases of the phase system described herein.

If this description says that the glasses are free of any component or any constituting phase or do not contain a certain component or constituting phase, this means that this component or constituting phase may be present at most as impurity in the glasses. This means that they are not added in significant amounts. According to the invention, insignificant amounts are amounts of less than 5000 ppm (in molar terms, based on the oxides), preferably less than 4000 ppm (in molar terms, based on the oxides, further preferably less than 3000 ppm (in molar terms, based on the oxides), further preferably less than 2000 ppm (in molar terms, based on the oxides), further preferably less than 1000 ppm (in molar terms, based on the oxides), preferably less than 500 ppm (in molar terms, based on the oxides), preferably less than 300 ppm (in molar terms, based on the oxides), more preferably less than 100 ppm (in molar terms, based on the oxides, even more preferably less than 50 ppm (in molar terms, based on the oxides) and most preferably less than 10 ppm (in molar terms, based on the oxides). The glasses of this invention are especially free of uranium, lead, arsenic, antimony, bismuth and/or cadmium.

The residue does not occur in the formulae. All calculations are done as if the proportion consisting of the constituting phases added up to 100%.

### Differences Between Trigonal Boron and Tetracoordinated Boron

All glasses of the invention can be represented as a combination of the constituting phases listed in table 2, taking account of the proportion limits specified in said table. Glasses that do not permit this are not in accordance with the invention. These in particular include all glasses which, like the glasses of the invention, have corresponding proportions of the oxides SiO₂, B₂O₃, Al₂O₃, Li₂O, Na₂O, K₂O and/or MgO, but have an excess of boron.

The glasses of the invention do not have an excess of boron. In particular, the following is applicable to the glasses of the invention:

$$( \sum {R}_{2} O + \sum R O ) \geq ( A {l}_{2} {O}_{3} + {B}_{2} {O}_{3} ) \qquad ( 12 a )$$

According to the invention, ΣR₂O+ΣRO means the sum total of the proportions of the alkali metal oxides and the alkaline earth metal oxides, especially the sum total of the proportions of Li₂O, Na₂O, K₂O, MgO, CaO, SrO and BaO. The glasses of the invention preferably include only small proportions of CaO, SrO and BaO or are entirely free of CaO, SrO and/or BaO. These oxides are not accounted for by any of the constituting phases of the invention and should therefore be assigned to the above-described residue, the proportion of which is preferably small. In preferred embodiments, (12a) can therefore be simplified as follows:

$$( L {i}_{2} O + N {a}_{2} O + {K}_{2} O + M g O ) \geq ( A {l}_{2} {O}_{3} + {B}_{2} {O}_{3} ) \qquad ( 12 b )$$

In inequations (12a, b), the chemical formulae of the individual simple oxides represent the molar proportion thereof in the respective glass. It is a feature of glasses in which inequation (12a) and/or inequation (12b) is applicable that the oxygen provided by the alkali metal and alkaline earth metal oxides is transferred primarily to the aluminum atoms present in order to enable these to tetracoordinate mentioned above; see, for example, S. Bruns, T. Uesbeck, D. Weil, D. Möncke, L. van Wüllen, K. Durst, D. de Ligny, Influence of Al2O3 Addition on Structure and Mechanical Properties of Borosilicate Glasses, Front. Mater. 7:189 (2020). The remaining oxygen provided by the alkali metal and alkaline earth metal oxides is used to enable boron atoms to tetracoordinate. In view of the excess of alkali metal and alkaline earth metal oxides, there remains no excess boron that could go ONLY into trigonal coordination for lack of additional oxygen. The glasses of the invention thus preferably contain tetracoordinated boron, but are in particular free of trigonal boron.

Trigonal boron is disadvantageous for a barrier material. This is because trigonal boron tends to aggregate to form larger planar structures, the boroxol rings. Parallel to these boroxol rings, diffusion pathways arise, which increase hydrogen permeability. This is also shown in measurements. Welter et al., in T. Welter, R. Müller J. Deubener, U. Marzok and S. Reinsch, Hydrogen Permeation Through Glass, Front. Mater. 6:342 (2020), compared literature values for borosilicates, aluminosilicates and binary silicates.

The borosilicates are the barium borosilicate glass referred to as “BABS” and examined by Ried et al. in P. Ried, M. Gaber, R. Müller, J. Deubener, Hydrogen permeability of a barium-aluminoborosilicate glass—A methodical approach, Journal of Non-Crystalline Solids 394-395 (2014), 43-49, and the borosilicate glass referred to as “BS3” and examined by the same authors in the same publication, and the “Corning Codes 3320, 7040, 7052, 7720, 7740, and 7900” systems considered by Shelby in James E. Shelby, Handbook of Diffusion in Solids and Melts, ASM International, Chicago, IL (1996). In all these glasses, the sum of the molar proportions of B₂O₃ and Al₂O₃ is greater than the sum of the molar proportions of the alkali metal oxides R₂O and the alkaline earth metal oxides RO. Thus none of the glasses satisfies inequation (12a).

They are thus not in accordance with the invention and are also notable for relatively high hydrogen permeabilities. The hydrogen permeabilities of the borosilicate glasses considered by Ried and Shelby, which are discussed by Welter et al., are higher than those of the aluminosilicates and binary silicates likewise considered by Welter et al. It can be concluded from the analysis of the composition in the light of inequations (12a, b) that the hydrogen permeability-lowering effect of the plugged structures present in the examples of Ried and Shelby are more than compensated for by the hydrogen permeability-increasing effect of trigonally coordinated boron which is present to a high degree.

### Preferred Glass Compositions

The preferred embodiments, in the context of the abovementioned base system, arise from the specification of a desired thermal expansion, density and packing density or of a respectively desired range for the parameters mentioned.

The glass is preferably characterized by the following oxide composition:

| | Min (mol %) | Max (mol %) |
|---|---|---|
| SiO₂ | 50 | 75 |
| B₂O₃ | 0 | 25 |
| Al₂O₃ | 0 | 25 |
| MgO | 0 | 25 |
| Li₂O | 0 | 25 |
| Na₂O | 0 | 30 |
| K₂O | 0 | 25 |
| ΣR₂O | 0 | 30 |
| ΣRO | 0 | 25 |
| ΣR₂O + ΣRO | 10 | 30 |
| ΣLi₂O + MgO | 1 | 30 |

The proportion of SiO₂ may, for example, be at least 50 mol %, at least 51 mol %, at least 52 mol %, at least 55 mol %, or at least 57 mol %. The proportion of SiO₂ may, for example, be at most 75 mol %, at most 70 mol %, at most 68 mol %, at most 65 mol %, at most 64 mol %, or at most 63 mol %. The proportion of SiO₂ may, for example, be in a range from 50 to 75 mol %, from 50 to 70 mol %, from 51 to 68 mol %, from 52 to 65 mol %, from 55 to 64 mol %, or from 57 to 63 mol %.

The proportion of B₂O₃ may, for example, be at least 1.0 mol %, at least 2.0 mol %, at least 3.0 mol %, at least 4.0 mol %, or at least 5.0 mol %. The proportion of B₂O₃ may, for example, be at most 25 mol %, at most 20 mol %, at most 18 mol %, at most 15 mol %, at most 13 mol %, or at most 11 mol %. The proportion of B₂O₃ may, for example, be in a range from 0.0 to 25 mol %, from 0.0 to 20 mol %, from 1.0 to 18 mol %, from 2.0 to 15 mol %, from 4.0 to 13 mol %, or from 5.0 to 11 mol %.

The proportion of Al₂O₃ may, for example, be at least 1.0 mol %, at least 2.0 mol %, at least 5.0 mol %, at least 10 mol %, at least 11 mol %, at least 12 mol %, at least 13 mol %, or at least 14 mol %. The proportion of Al₂O₃ may, for example, be at most 25 mol %, at most 24 mol %, at most 23 mol %, at most 22 mol %, at most 21 mol %, at most 20 mol %, at most 19 mol %, at most 18 mol %, or at most 17 mol %. The proportion of Al₂O₃ may, for example, be in a range from 0.0 to 25 mol %, from 1.0 to 24 mol %, from 2.0 to 23 mol %, from 5.0 to 22 mol %, from 10 to 21 mol %, from 11 to 20 mol %, from 12 to 19 mol %, from 13 to 18 mol %, or from 14 to 17 mol %.

The sum total of the proportions of B₂O₃ and Al₂O₃ may, for example, be at least 5.0 mol %, at least 8.0 mol %, at least 10 mol %, at least 15 mol %, or at least 17 mol %. The sum total of the proportions of B₂O₃ and Al₂O₃ may, for example, be at most 30 mol %, at most 28 mol %, at most 26 mol %, at most 25 mol %, or at most 24 mol %. The sum total of the proportions of B₂O₃ and Al₂O₃ may, for example, be in a range from 5.0 to 30 mol %, from 8.0 to 28 mol %, from 10 to 26 mol %, from 15 to 25 mol %, or from 17 to 24 mol %.

The proportion of MgO may, for example, be at least 1.0 mol %, at least 2.0 mol %, at least 3.0 mol %, at least 4.0 mol %, at least 5.0 mol %, at least 6.0 mol %, at least 7.0 mol %, or at least 8.0 mol %. The proportion of MgO may, for example, be at most 30 mol %, at most 25 mol %, at most 23 mol %, at most 20 mol %, at most 18 mol %, at most 15 mol %, at most 14 mol %, at most 12 mol %, or at most 10 mol %. The proportion of MgO may, for example, be in a range from 0.0 to 30 mol %, from 1.0 to 25 mol %, from 2.0 to 23 mol %, from 3.0 to 20 mol %, from 4.0 to 18 mol %, from 5.0 to 15 mol %, from 6.0 to 14 mol %, from 7.0 to 12 mol %, or from 8.0 to 10 mol %. MgO has been found to be particularly advantageous for the achievement of low hydrogen permeability.

The proportion of Li₂O may, for example, be at least 1.0 mol %, at least 2.0 mol %, at least 5.0 mol %, at least 10 mol %, at least 15 mol % or at least 20 mol %. The proportion of Li₂O may, for example, be at most 25 mol %, at most 20 mol %, at most 15 mol %, at most 10 mol %, or at most 5.0 mol %. The proportion of Li₂O may, for example, be in a range from 0.0 to 25 mol %, from 0.0 to 20 mol %, from 0.0 to 15 mol %, from 1.0 to 10 mol %, or from 2.0 to 5.0 mol %.

The proportion of Na₂O may, for example, be at least 1.0 mol %, at least 2.0 mol %, at least 4.0 mol %, at least 5.0 mol %, or at least 7.0 mol %. The proportion of Na₂O may, for example, be at most 30 mol %, at most 25 mol %, at most 20 mol %, at most 15 mol %, at most 15 mol %, at most 14 mol %, at most 13 mol %, at most 12 mol %, or at most 11 mol %. The proportion of Na₂O may, for example, be in a range from 0.0 to 30 mol %, from 0.0 to 25 mol %, from 0.0 to 20 mol %, from 0.0 to 15 mol %, from 1.0 to 14 mol %, from 2.0 to 13 mol %, from 4.0 to 12 mol %, or from 5.0 to 11 mol %.

The proportion of K₂O may, for example, be at least 1.0 mol %, at least 2.0 mol %, at least 3.0 mol %, at least 4.0 mol %, or at least 5.0 mol %. The proportion of K₂O may, for example, be at most 25 mol %, at most 20 mol %, at most 15 mol %, at most 12 mol %, at most 10 mol %, at most 8.0 mol %, or at most 6.0 mol %. The proportion of K₂O may, for example, be in a range from 0.0 to 25 mol %, from 0.0 to 20 mol %, from 0.0 to 15 mol %, from 0.0 to 12 mol %, from 0.0 to 10 mol %, from 0.0 to 8.0 mol %, or from 0.0 to 6.0 mol %.

According to the invention, ΣR₂O means the sum total of the proportions of the alkali metal oxides, in particular the sum total of the proportions of Li₂O, Na₂O and K₂O. ΣR₂O may, for example, be at least 1.0 mol %, at least 2.0 mol %, at least 4.0 mol %, at least 5.0 mol %, or at least 6.0 mol %. ΣR₂O may, for example, be at most 30 mol %, at most 25 mol %, at most 22 mol %, at most 20 mol %, at most 18 mol %, or at most 17 mol %. ΣR₂O may, for example, be in a range from 0.0 to 30 mol %, from 0.0 to 25 mol %, from 1.0 to 22 mol %, from 2.0 to 20 mol %, from 4.0 to 18 mol %, or from 5.0 to 17 mol %.

According to the invention, ΣRO means the sum total of the proportions of the alkaline earth metal oxides, in particular the sum total of the proportions of MgO, CaO, SrO and BaO. ΣRO may, for example, be at least 1.0 mol %, at least 2.0 mol %, at least 5.0 mol %, at least 6.0 mol %, or at least 8.0 mol %. ΣRO may, for example, be at most 25 mol %, at most 20 mol %, at most 18 mol %, at most 15 mol %, or at most 14 mol %. ΣRO may, for example, be in a range from 0.0 to 25 mol %, from 2.0 to 20 mol %, from 5.0 to 18 mol %, from 6.0 to 15 mol %, or from 8.0 to 14 mol %.

According to the invention, ΣR₂O+ΣRO means the sum total of the proportions of the alkali metal oxides and the alkaline earth metal oxides, in particular the sum total of the proportions of Li₂O, Na₂O, K₂O, MgO, CaO, SrO and BaO. ΣR₂O+ΣRO may, for example, be at least 5.0 mol %, at least 8.0 mol %, at least 10 mol %, at least 12 mol %, at least 15 mol %, or at least 17 mol %. ΣR₂O+ΣRO may, for example, be at most 30 mol %, at most 28 mol %, at most 27 mol % at most 26 mol %, at most 25 mol %, or at most 24 mol %. ΣR₂O+ΣRO may, for example, be in a range from 5.0 to 30 mol %, from 8.0 to 28 mol %, from 10 to 27 mol %, from 12 to 26 mol %, from 15 to 25 mol %, or from 17 to 24 mol %.

The ratio of the molar proportions of the sum totals of ΣR₂O+ΣRO and B₂O₃+Al₂O₃ may be of particular significance, i.e. the ratio of proportions (ΣR₂O+ΣRO)/(B₂O₃+Al₂O₃). It is advantageous when the molar proportions of the sum total ΣR₂O+ΣRO and the molar proportions of the sum total B₂O₃+Al₂O₃ are similar or even the same, such that the ratio of proportions (ΣR₂O+ΣRO)/(B₂O₃+Al₂O₃) is close to or equal to 1:1. If the ratio of proportions is too high, there are too many non-bridging oxygen atoms (NBO), which has an adverse effect on chemical resistance. It is preferable that the ratio of proportions (ΣR₂O+ΣRO)/(B₂O₃+Al₂O₃) is at least 1.00:1.00. If the ratio of proportions is too small, there is too much trigonal boron (which has an adverse effect on the desired barrier effect with respect to hydrogen) or, in the case of absence of boron, the system has a tendency to devitrification. The ratio of proportions (ΣR₂O+ΣRO)/(B₂O₃+Al₂O₃) may, for example, be in a range from 1.00:1 to 1.25:1, from 1.00:1 to 1.20:1, from 1.00:1 to 1.15:1, from 1.00:1 to 1.10:1, from 1.00:1 to 1.05:1, from 1.00:1 to 1.02:1, or from 1.00:1 to 1.01:1, or may be 1:1, for example about 1.00:1.00. The ratio of proportions (ΣR₂O+ΣRO)/(B₂O₃+Al₂O₃) is at least about 1.00:1.00. The ratio of proportions (ΣR₂O+ΣRO)/(B₂O₃+Al₂O₃) may, for example, be at most 1.25:1, at most 1.20:1, at most 1.15:1, at most 1.10:1, at most 1.05:1, at most 1.02:1, at most 1.01:1, or at most 1:1, for example at most about 1.00:1.00.

The difference in the molar proportions of the sum totals ΣR₂O+ΣRO and B₂O₃+Al₂O₃ may be of particular significance, i.e. (ΣR₂O+ΣRO)−(B₂O₃+Al₂O₃). It is advantageous when the molar proportions of the sum total ΣR₂O+ΣRO and the molar proportions of the sum total B₂O₃+Al₂O₃ are similar or even the same, such that the difference (ΣR₂O+ΣRO)−(B₂O₃+Al₂O₃) is close to or equal to 0. If the alkali metals and alkaline earth metals are in a large excess, there are too many non-bridging oxygen atoms (NBO). If, by contrast, B₂O₃ and Al₂O₃ are present in excess, there is too much trigonal boron. Trigonal boron has an adverse effect on the desired barrier effect with respect to hydrogen. In particular, an excess of B₂O₃+Al₂O₃ should therefore be avoided. Preferably, the difference (ΣR₂O+ΣRO)−(B₂O₃+Al₂O₃)≥0 mol %.

The sum total of the proportions of Li₂O and MgO may also be of particular significance. The sum total of the proportions of Li₂O and MgO may, for example, be in a range from 1.0 to 30 mol %, from 2.0 to 25 mol %, from 5.0 to 20 mol %, or from 10 to 15 mol %. The sum total of the proportions of Li₂O and MgO may, for example, be at least 1.0 mol %, at least 2.0 mol %, at least 5.0 mol %, or at least 10 mol %, in some embodiments even at least 15 mol % or at least 20 mol %. The sum total of the proportions of Li₂O and MgO may, for example, be at most 30 mol %, at most 25 mol %, or at most 20 mol %, in some embodiments even at most 15 mol % or at most 10 mol %.

The proportion of MgO is preferably greater than the proportion of Li₂O. MgO can achieve a particularly low hydrogen permeability. The proportion of MgO is preferably by at least 1.0 mol %, further preferably at least 2.0 mol %, further preferably at least 3.0 mol %, further preferably at least 4.0 mol %, further preferably at least 5.0 mol %, further preferably at least 6.0 mol %, greater than the proportion of Li₂O. The proportion of MgO may, for example, be by at most 30 mol %, at most 25 mol %, at most 20 mol %, at most 15 mol %, at most 12 mol % or at most 10 mol %, greater than the proportion of Li₂O. The difference between the proportions of MgO and Li₂O may, for example, be in a range from 1.0 to 30 mol %, from 2.0 to 25 mol %, from 3.0 to 20 mol %, from 4.0 to 15 mol %, from 5.0 to 12 mol % or from 6.0 to 10 mol %.

A preferred composition is characterized by the following composition ranges:

| | Min (mol %) | Max (mol %) |
|---|---|---|
| SiO₂ | 50 | 70 |
| B₂O₃ | 0 | 20 |
| Al₂O₃ | 10 | 25 |
| MgO | 0 | 25 |
| Li₂O | 0 | 25 |
| Na₂O | 0 | 15 |
| K₂O | 0 | 15 |
| ΣR₂O | 0 | 25 |
| ΣRO | 0 | 25 |
| ΣR₂O + ΣRO | 10 | 30 |

A further-preferred composition is characterized by the following composition ranges:

| | Min (mol %) | Max (mol %) |
|---|---|---|
| SiO₂ | 51 | 68 |
| B₂O₃ | 1 | 18 |
| Al₂O₃ | 11 | 22 |
| MgO | 2 | 20 |
| Li₂O | 0 | 20 |
| Na₂O | 1 | 14 |
| K₂O | 0 | 12 |
| ΣR₂O | 1 | 22 |
| ΣRO | 2 | 20 |
| ΣR₂O + ΣRO | 10 | 28 |

A further-preferred composition is characterized by the following phases that constitute the glass:

| | Min (mol %) | Max (mol %) |
|---|---|---|
| SiO₂ | 52 | 65 |
| B₂O₃ | 2 | 15 |
| Al₂O₃ | 12 | 20 |
| MgO | 5 | 18 |
| Li₂O | 0 | 15 |
| Na₂O | 2 | 13 |
| K₂O | 0 | 10 |
| ΣR₂O | 2 | 20 |
| ΣRO | 5 | 18 |
| ΣR₂O + ΣRO | 10 | 26 |

A further-preferred composition is characterized by the following composition ranges:

| | Min (mol %) | Max (mol %) |
|---|---|---|
| SiO₂ | 55 | 64 |
| B₂O₃ | 4 | 13 |
| Al₂O₃ | 13 | 18 |
| MgO | 6 | 15 |
| Li₂O | 0 | 10 |
| Na₂O | 4 | 12 |
| K₂O | 0 | 8 |
| ΣR₂O | 4 | 18 |
| ΣRO | 6 | 15 |
| ΣR₂O + ΣRO | 15 | 25 |

A further-preferred composition is characterized by the following composition ranges:

| | Min (mol %) | Max (mol %) |
|---|---|---|
| SiO₂ | 57 | 63 |
| B₂O₃ | 5 | 11 |
| Al₂O₃ | 14 | 17 |
| MgO | 8 | 14 |
| Li₂O | 0 | 5 |
| Na₂O | 5 | 11 |
| K₂O | 0 | 6 |
| ΣR₂O | 5 | 17 |
| ΣRO | 8 | 14 |
| ΣR₂O + ΣRO | 17 | 24 |

A further-preferred composition is characterized by the following composition ranges:

| | Min (mol %) | Max (mol %) |
|---|---|---|
| SiO₂ | 50 | 70 |
| B₂O₃ | 1 | 20 |
| Al₂O₃ | 1 | 24 |
| MgO | 1 | 20 |
| Li₂O | 0 | 15 |
| Na₂O | 1 | 25 |
| K₂O | 0 | 20 |
| ΣR₂O | 1 | 25 |
| ΣRO | 1 | 20 |
| ΣR₂O + ΣRO | 12 | 28 |
| ΣLi₂O + MgO | 2 | 25 |

A further-preferred composition is characterized by the following composition ranges:

| | Min (mol %) | Max (mol %) |
|---|---|---|
| SiO₂ | 50 | 68 |
| B₂O₃ | 2 | 18 |
| Al₂O₃ | 2 | 22 |
| MgO | 2 | 18 |
| Li₂O | 0 | 10 |
| Na₂O | 2 | 20 |
| K₂O | 0 | 15 |
| ΣR₂O | 4 | 22 |
| ΣRO | 2 | 18 |
| ΣR₂O + ΣRO | 15 | 27 |
| ΣLi₂O + MgO | 5 | 20 |

A further-preferred composition is characterized by the following composition ranges:

| | Min (mol %) | Max (mol %) |
|---|---|---|
| SiO₂ | 50 | 65 |
| B₂O₃ | 3 | 15 |
| Al₂O₃ | 5 | 20 |
| MgO | 4 | 18 |
| Li₂O | 0 | 5 |
| Na₂O | 4 | 15 |
| K₂O | 0 | 12 |
| ΣR₂O | 5 | 20 |
| ΣRO | 4 | 18 |
| ΣR₂O + ΣRO | 17 | 26 |
| ΣLi₂O + MgO | 5 | 20 |

The composition of the glasses of the invention is preferably characterized by the following phases that constitute the glass:

| | Formula (normalized | Min | Max |
|---|---|---|---|
| Constituting phase | to a simple oxide) | (mol %) | (mol %) |
| Silicon dioxide | SiO₂ | 0 | 50 |
| Sodium sheet silicate | (3Na₂O•8SiO₂)/11 | 0 | 50 |
| Cordierite | (2MgO•2Al₂O₃•5SiO₂)/9 | 0 | 100 |
| Nepheline | (Na₂O•Al₂O₃•2SiO₂)/4 | 0 | 100 |
| Eucryptite | (Li₂O•Al₂O₃•2SiO₂)/4 | 0 | 100 |
| Malinkoite | (Na₂O•B₂O₃•2SiO₂)/4 | 0 | 100 |
| Kalsilite | (K₂O•Al₂O₃•2SiO₂)/4 | 0 | 40 |

Further preferably, the composition of the glasses of the invention is characterized by the following phases that constitute the glass:

| | Formula (normalized | Min | Max |
|---|---|---|---|
| Constituting phase | to a simple oxide) | (mol %) | (mol %) |
| Silicon dioxide | SiO₂ | 0 | 35 |
| Sodium sheet silicate | (3Na₂O•8SiO₂)/11 | 0 | 25 |
| Cordierite | (2MgO•2Al₂O₃•5SiO₂)/9 | 5 | 90 |
| Nepheline | (Na₂O•Al₂O₃•2SiO₂)/4 | 0 | 25 |
| Eucryptite | (Li₂O•Al₂O₃•2SiO₂)/4 | 0 | 80 |
| Malinkoite | (Na₂O•B₂O₃•2SiO₂)/4 | 5 | 90 |
| Kalsilite | (K₂O•Al₂O₃•2SiO₂)/4 | 0 | 40 |

Further preferably, the composition of the glasses of the invention is characterized by the following phases that constitute the glass:

| | Formula (normalized | Min | Max |
|---|---|---|---|
| Constituting phase | to a simple oxide) | (mol %) | (mol %) |
| Silicon dioxide | SiO₂ | 0 | 25 |
| Sodium sheet silicate | (3Na₂O•8SiO₂)/11 | 0 | 20 |
| Cordierite | (2MgO•2Al₂O₃•5SiO₂)/9 | 10 | 80 |
| Nepheline | (Na₂O•Al₂O₃•2SiO₂)/4 | 0 | 20 |
| Eucryptite | (Li₂O•Al₂O₃•2SiO₂)/4 | 0 | 50 |
| Malinkoite | (Na₂O•B₂O₃•2SiO₂)/4 | 10 | 80 |
| Kalsilite | (K₂O•Al₂O₃•2SiO₂)/4 | 0 | 40 |

Further preferably, the composition of the glasses of the invention is characterized by the following phases that constitute the glass:

| | Formula (normalized | Min | Max |
|---|---|---|---|
| Constituting phase | to a simple oxide) | (mol %) | (mol %) |
| Silicon dioxide | SiO₂ | 0 | 20 |
| Sodium sheet silicate | (3Na₂O•8SiO₂)/11 | 0 | 15 |
| Cordierite | (2MgO•2Al₂O₃•5SiO₂)/9 | 20 | 75 |
| Nepheline | (Na₂O•Al₂O₃•2SiO₂)/4 | 0 | 15 |
| Eucryptite | (Li₂O•Al₂O₃•2SiO₂)/4 | 0 | 20 |
| Malinkoite | (Na₂O•B₂O₃•2SiO₂)/4 | 20 | 70 |
| Kalsilite | (K₂O•Al₂O₃•2SiO₂)/4 | 0 | 40 |

Further preferably, the composition of the glasses of the invention is characterized by the following phases that constitute the glass:

| | Formula (normalized | Min | Max |
|---|---|---|---|
| Constituting phase | to a simple oxide) | (mol %) | (mol %) |
| Silicon dioxide | SiO₂ | 0 | 15 |
| Sodium sheet silicate | (3Na₂O•8SiO₂)/11 | 0 | 10 |
| Cordierite | (2MgO•2Al₂O₃•5SiO₂)/9 | 25 | 70 |
| Nepheline | (Na₂O•Al₂O₃•2SiO₂)/4 | 0 | 10 |
| Eucryptite | (Li₂O•Al₂O₃•2SiO₂)/4 | 0 | 15 |
| Malinkoite | (Na₂O•B₂O₃•2SiO₂)/4 | 25 | 60 |
| Kalsilite | (K₂O•Al₂O₃•2SiO₂)/4 | 0 | 40 |

Further preferably, the composition of the glasses of the invention is characterized by the following phases that constitute the glass:

| | Formula (normalized | Min | Max |
|---|---|---|---|
| Constituting phase | to a simple oxide) | (mol %) | (mol %) |
| Silicon dioxide | SiO₂ | 0 | 10 |
| Sodium sheet silicate | (3Na₂O•8SiO₂)/11 | 0 | 5 |
| Cordierite | (2MgO•2Al₂O₃•5SiO₂)/9 | 30 | 60 |
| Nepheline | (Na₂O•Al₂O₃•2SiO₂)/4 | 0 | 5 |
| Eucryptite | (Li₂O•Al₂O₃•2SiO₂)/4 | 0 | 10 |
| Malinkoite | (Na₂O•B₂O₃•2SiO₂)/4 | 30 | 50 |
| Kalsilite | (K₂O•Al₂O₃•2SiO₂)/4 | 0 | 40 |

Further preferably, the composition of the glasses of the invention is characterized by the following phases that constitute the glass:

| | Formula (normalized | Min | Max |
|---|---|---|---|
| Constituting phase | to a simple oxide) | (mol %) | (mol %) |
| Silicon dioxide | SiO₂ | 0 | 40 |
| Sodium sheet silicate | (3Na₂O•8SiO₂)/11 | 0 | 25 |
| Cordierite | (2MgO•2Al₂O₃•5SiO₂)/9 | 5 | 90 |
| Nepheline | (Na₂O•Al₂O₃•2SiO₂)/4 | 0 | 25 |
| Eucryptite | (Li₂O•Al₂O₃•2SiO₂)/4 | 0 | 50 |
| Malinkoite | (Na₂O•B₂O₃•2SiO₂)/4 | 5 | 80 |
| Kalsilite | (K₂O•Al₂O₃•2SiO₂)/4 | 0 | 40 |

Further preferably, the composition of the glasses of the invention is characterized by the following phases that constitute the glass:

| | Formula (normalized | Min | Max |
|---|---|---|---|
| Constituting phase | to a simple oxide) | (mol %) | (mol %) |
| Silicon dioxide | SiO₂ | 0 | 30 |
| Sodium sheet silicate | (3Na₂O•8SiO₂)/11 | 0 | 10 |
| Cordierite | (2MgO•2Al₂O₃•5SiO₂)/9 | 10 | 80 |
| Nepheline | (Na₂O•Al₂O₃•2SiO₂)/4 | 0 | 10 |
| Eucryptite | (Li₂O•Al₂O₃•2SiO₂)/4 | 0 | 25 |
| Malinkoite | (Na₂O•B₂O₃•2SiO₂)/4 | 10 | 70 |
| Kalsilite | (K₂O•Al₂O₃•2SiO₂)/4 | 0 | 40 |

Further preferably, the composition of the glasses of the invention is characterized by the following phases that constitute the glass:

| | Formula (normalized | Min | Max |
|---|---|---|---|
| Constituting phase | to a simple oxide) | (mol %) | (mol %) |
| Silicon dioxide | SiO₂ | 0 | 25 |
| Sodium sheet silicate | (3Na₂O•8SiO₂)/11 | 0 | 5 |
| Cordierite | (2MgO•2Al₂O₃•5SiO₂)/9 | 20 | 70 |
| Nepheline | (Na₂O•Al₂O₃•2SiO₂)/4 | 0 | 5 |
| Eucryptite | (Li₂O•Al₂O₃•2SiO₂)/4 | 0 | 20 |
| Malinkoite | (Na₂O•B₂O₃•2SiO₂)/4 | 15 | 60 |
| Kalsilite | (K₂O•Al₂O₃•2SiO₂)/4 | 0 | 40 |

The invention preferably relates to a glass comprising the following components in the proportions specified (in mol %):

| | Min | Max |
|---|---|---|
| | (mol %) | (mol %) |
| SiO₂ | 50 | 75 |
| B₂O₃ | 0 | 25 |
| Al₂O₃ | 0 | 25 |
| MgO | 0 | 25 |
| Li₂O | 0 | 25 |
| Na₂O | 0 | 30 |
| K₂O | 0 | 25 |
| ΣR₂O | 0 | 30 |
| ΣRO | 0 | 25 |
| ΣR₂O + ΣRO | 10 | 30 |
| ΣLi₂O + MgO | 1 | 30 |

where the sum total of the molar proportions of the alkali metal oxides R₂O and the alkaline earth metal oxides RO is equal to or greater than the sum total of the molar proportions of B₂O₃ and Al₂O₃, where the composition of the glass is additionally characterized by the following phases constituting the glass:

| | Formula (normalized | Min | Max |
|---|---|---|---|
| Constituting phase | to a simple oxide) | (mol %) | (mol %) |
| Silicon dioxide | SiO₂ | 0 | 50 |
| Sodium sheet silicate | (3Na₂O•8SiO₂)/11 | 0 | 50 |
| Cordierite | (2MgO•2Al₂O₃•5SiO₂)/9 | 0 | 100 |
| Nepheline | (Na₂O•Al₂O₃•2SiO₂)/4 | 0 | 100 |
| Eucryptite | (Li₂O•Al₂O₃•2SiO₂)/4 | 0 | 100 |
| Malinkoite | (Na₂O•B₂O₃•2SiO₂)/4 | 0 | 100 |
| Kalsilite | (K₂O•Al₂O₃•2SiO₂)/4 | 0 | 40 |

and where the decadic logarithm of hydrogen permeability p, calculated by formula (10), is less than −20.000.

More preferably, the invention relates to a glass comprising the following components in the proportions specified (in mol %):

| | Min | Max |
|---|---|---|
| | (mol %) | (mol %) |
| SiO₂ | 50 | 70 |
| B₂O₃ | 1 | 20 |
| Al₂O₃ | 1 | 24 |
| MgO | 1 | 20 |
| Li₂O | 0 | 15 |
| Na₂O | 1 | 25 |
| K₂O | 0 | 20 |
| ΣR₂O | 1 | 25 |
| ΣRO | 1 | 20 |
| ΣR₂O + ΣRO | 12 | 28 |
| ΣLi₂O + MgO | 2 | 25 |

where the sum total of the molar proportions of the alkali metal oxides R₂O and the alkaline earth metal oxides RO is equal to or greater than the sum total of the molar proportions of B₂O₃ and Al₂O₃, where the composition of the glass is additionally characterized by the following phases constituting the glass:

| | Formula (normalized | Min | Max |
|---|---|---|---|
| Constituting phase | to a simple oxide) | (mol %) | (mol %) |
| Silicon dioxide | SiO₂ | 0 | 40 |
| Sodium sheet silicate | (3Na₂O•8SiO₂)/11 | 0 | 25 |
| Cordierite | (2MgO•2Al₂O₃•5SiO₂)/9 | 5 | 90 |
| Nepheline | (Na₂O•Al₂O₃•2SiO₂)/4 | 0 | 25 |
| Eucryptite | (Li₂O•Al₂O₃•2SiO₂)/4 | 0 | 50 |
| Malinkoite | (Na₂O•B₂O₃•2SiO₂)/4 | 5 | 80 |
| Kalsilite | (K₂O•Al₂O₃•2SiO₂)/4 | 0 | 40 |

and where the decadic logarithm of hydrogen permeability p, calculated by formula (10), is less than −20.500.

Further preferably, the invention relates to a glass comprising the following components in the proportions specified (in mol %):

| | Min | Max |
|---|---|---|
| | (mol %) | (mol %) |
| SiO₂ | 50 | 68 |
| B₂O₃ | 2 | 18 |
| Al₂O₃ | 2 | 22 |
| MgO | 2 | 18 |
| Li₂O | 0 | 10 |
| Na₂O | 2 | 20 |
| K₂O | 0 | 15 |
| ΣR₂O | 4 | 22 |
| ΣRO | 2 | 18 |
| ΣR₂O + ΣRO | 15 | 27 |
| ΣLi₂O + MgO | 5 | 20 |

where the sum total of the molar proportions of the alkali metal oxides R₂O and the alkaline earth metal oxides RO is equal to or greater than the sum total of the molar proportions of B₂O₃ and Al₂O₃, where the composition of the glass is additionally characterized by the following phases constituting the glass:

| | Formula (normalized | Min | Max |
|---|---|---|---|
| Constituting phase | to a simple oxide) | (mol %) | (mol %) |
| Silicon dioxide | SiO₂ | 0 | 30 |
| Sodium sheet silicate | (3Na₂O•8SiO₂)/11 | 0 | 10 |
| Cordierite | (2MgO•2Al₂O₃•5SiO₂)/9 | 10 | 80 |
| Nepheline | (Na₂O•Al₂O₃•2SiO₂)/4 | 0 | 10 |
| Eucryptite | (Li₂O•Al₂O₃•2SiO₂)/4 | 0 | 25 |
| Malinkoite | (Na₂O•B₂O₃•2SiO₂)/4 | 10 | 70 |
| Kalsilite | (K₂O•Al₂O₃•2SiO₂)/4 | 0 | 40 |

and where the decadic logarithm of hydrogen permeability p, calculated by formula (10), is less than −21.000.

Even further preferably, the invention relates to a glass comprising the following components in the proportions specified (in mol %):

| | Min | Max |
|---|---|---|
| | (mol %) | (mol %) |
| SiO₂ | 50 | 65 |
| B₂O₃ | 3 | 15 |
| Al₂O₃ | 5 | 20 |
| MgO | 4 | 18 |
| Li₂O | 0 | 5 |
| Na₂O | 4 | 15 |
| K₂O | 0 | 12 |
| ΣR₂O | 5 | 20 |
| ΣRO | 4 | 18 |
| ΣR₂O + ΣRO | 17 | 26 |
| ΣLi₂O + MgO | 5 | 20 |

where the sum total of the molar proportions of the alkali metal oxides R₂O and the alkaline earth metal oxides RO is equal to or greater than the sum total of the molar proportions of B₂O₃ and Al₂O₃, where the composition of the glass is additionally characterized by the following phases constituting the glass:

| | Formula (normalized | Min | Max |
|---|---|---|---|
| Constituting phase | to a simple oxide) | (mol %) | (mol %) |
| Silicon dioxide | SiO₂ | 0 | 25 |
| Sodium sheet silicate | (3Na₂O•8SiO₂)/11 | 0 | 5 |
| Cordierite | (2MgO•2Al₂O₃•5SiO₂)/9 | 20 | 70 |
| Nepheline | (Na₂O•Al₂O₃•2SiO₂)/4 | 0 | 5 |
| Eucryptite | (Li₂O•Al₂O₃•2SiO₂)/4 | 0 | 20 |
| Malinkoite | (Na₂O•B₂O₃•2SiO₂)/4 | 15 | 60 |
| Kalsilite | (K₂O•Al₂O₃•2SiO₂)/4 | 0 | 40 |

and where the decadic logarithm of hydrogen permeability p, calculated by formula (10), is less than −21.500.

### Production

The invention also relates to a process for producing a hydrogen storage medium, especially a hydrogen storage medium of the present invention. The process preferably comprises the following steps:
forming a combination material, especially a material composite or a composite material, to a wall, where the wall has one or more openings,
introducing a valve into each of the openings.

The invention also relates to a process for producing a combination material, for example a material composite or a composite material, especially combination material, for example a material composite or a composite material of the present invention. The process preferably comprises the following steps:
providing a barrier material,
providing a reinforcing material,
combining the barrier material and the reinforcing material to give a combination material, especially to give a material composite or to give a composite material.

In the case of the composite material, the bonding can be effected, for example, by hot pressing, rolling or hot isostatic pressing (in particular three-dimensional onto core), or combinations of two or more of these.

In the case of the material composite, bonding solutions are also possible. In particular, the reinforcing material (for example carbon fiber-reinforced plastic (CFRP)) can be bonded to the barrier material with the aid of a bonding means (in particular) of an adhesive, for example with one or more organic polymers, especially resins. For example, it is possible to wrap a pipe made of barrier material on the outside with reinforcing material in resin. The curing can also be effected at elevated temperature, preferably at temperatures of less than 250° C.

If bonding means used are to be materials that are endogenous with respect to the barrier material (for example glass powder), this can be applied, for example, in the form of a particle suspension (glass powder in/with a binder solution, for example polyvinylbutyral (PVB) in ethanol (EtOH)) or else as sol-gel.

As well as impregnation of the reinforcing material with the sol-gel, spraying processes are also possible.

The outside of a pipe can then in turn be wrapped. The inside thereof, by contrast, and is also the case with resins, is amenable primarily to lamination techniques.

In the case of particles and/or a sol-gel, one or more heat treatment steps are preferably provided, for example sol-gel transformation, binder burnoff, and/or compaction of the composite. The heat treatment is preferably effected at temperatures below the glass transition temperature Tg of the barrier material. It is also possible that the wrapping of a pipe on the outside and the heat treatment are effected in parallel.

In order to achieve particularly intimate bonding of barrier material and reinforcing material, it may be preferable to first subject the barrier material to a surface treatment, especially a chemical and/or physical pretreatment (for example with plasma) or the application of adhesion promoters (especially primers).

When carbon fibers are used, the tendency thereof to degradation at elevated temperature under standard atmosphere should be taken into account. Processing or the performance of thermal processes under protective gas may be preferred.

The invention also includes a process for producing a glass or glass article of this invention, comprising the steps of:
melting the glass raw materials,
forming a glass article,
cooling the glass.

The forming of the glass may comprise a drawing method, especially a pipe drawing method or a drawing method for flat glass or fibers. The cooling may be an active cooling operation using a coolant, for example a cooling fluid, or be conducted by passive cooling.

More preferably, the forming comprises a flat glass method, for example a drawing method. Such a method can be used to obtain glass layers or glass films. Such a configuration of the glass article or glass is particularly advantageous for the attainment of the desired low hydrogen permeability.

The invention also includes a process for producing a glass via a coating method.

The invention also includes a process for producing a combination material, especially a material composite or a composite material comprising or consisting of a carbon fiber- or silicon carbide fiber-reinforced glass using the glass of the invention for the glass matrix.

### Uses and Glass Articles

The invention also includes glass articles formed from the glass, such as glass tubes.

The invention also relates to a glass article comprising or consisting of the glass of the invention. Especially in the case of use in the or as barrier material, the glass article is sheetlike and hence nonfibrous. A fibrous configuration of the glass article would be associated with an increase in hydrogen permeability, which should be avoided in accordance with the invention. Instead, hydrogen permeability should be low. Therefore, the glass article of the invention is preferably nonfibrous. Preference is given instead to a sheetlike configuration of the glass article. The glass article is preferably in laminar configuration, for example in the form of a glass layer or a glass film. The glass article is thus preferably in the form of a glass layer, especially in the form of a glass film. The glass article is preferably a glass layer or a glass film.

The invention also relates to a combination material, for example a material composite, especially a layer composite, comprising or consisting of the glass of the invention and at least one further layer. The further layer may especially comprise carbon fibers and/or silicon carbide fibers.

The present invention also relates to the use of the glass of the invention for glass layers.

The invention also relates to the use of a glass or glass article of the invention in the or as barrier material of the wall of a hydrogen storage medium, especially a hydrogen storage medium of the invention.

The invention also relates to the use of a glass or glass article of the invention in the or as barrier material of a combination material, especially a combination material of the invention, to the combination material comprising the barrier material and a reinforcing material.

The present invention also relates to the use of the glass of the invention for fiber-reinforced glass.

The invention also relates to the use of the glass of the invention or combination material, especially material composites or composite material, or layer composite, in or as hydrogen storage medium, especially as barrier material for molecular hydrogen.

The hydrogen storage medium of the present invention (especially the wall thereof) preferably comprises the combination material, especially the material composite or the composite material of the present invention. The hydrogen storage medium of the present invention preferably comprises the glass of the present invention, especially in or as barrier material of the combination material, especially of the material composite or of the composite material of the wall.

The combination material, especially the material composite or the composite material of the present invention, preferably comprises the glass of the present invention. The barrier material of the combination material, especially of the material composite or of the composite material of the present invention, preferably comprises the glass of the present invention or consists of the glass of the present invention.

FIG. 1 shows a hydrogen storage medium 11 of the invention in a preferred embodiment with a wall made from a combination material comprising an inner barrier layer 13 (i.e. facing the cavity 12) made of a barrier material and an outer reinforcing layer 14 made of a reinforcing material. The reinforcing layer 14 is provided all around the barrier layer 13. The hydrogen storage medium comprises two valves 15 and 16 provided on opposite sides.

FIG. 2 shows a further preferred embodiment of the invention in the form of a hydrogen storage medium 21 having a cavity 22 and a wall comprising an inner barrier layer 23 made of a barrier material and an outer reinforcing layer 24 made of a reinforcing material. By contrast with FIG. 1, the reinforcing layer 24 is provided only on the longitudinal sides of the wall in FIG. 2. No reinforcing layer 24 is provided on the short sides where the valves 25 and 26 are also present. The wall is formed there solely by the barrier layer 23.

FIG. 3 shows two further embodiments of the invention in the form of a hydrogen storage medium 31a and a hydrogen storage medium 31b. The two hydrogen storage media 31a and 31b are in the form of bottles and comprise a cavity (32a, 32b) in which hydrogen can be stored. The valves 35a and 35b are provided at the top, i.e. at the opposite side from the base provided at the bottom (37a, 37b). In the hydrogen storage medium designated 31a (on the left in FIG. 3), a reinforcing layer 34a is arranged all around the barrier layer 33a. By contrast, the hydrogen storage medium 31b is configured such that no reinforcing layer 34b is provided in the upper region, especially close to the valve 35b, and so the wall there is formed solely by the barrier layer 33b.

### EXAMPLES

The invention is described further by way of example by selected examples hereinafter.

### Hydrogen Storage Medium

A hydrogen storage medium of the invention, in a preferred embodiment of the invention, has a wall made from a combination material that encloses a cavity in which hydrogen can be stored. The combination material comprises an inner barrier layer made from a barrier material and an outer reinforcing layer made from a reinforcing material. The barrier layer is in the form of a sheetlike material. The reinforcing layer is arranged all around the barrier layer. The hydrogen storage medium comprises two valves provided on opposite sides.

In a further preferred embodiment of the invention, a hydrogen storage medium having a cavity for storage of hydrogen and a wall is provided, which comprises an inner barrier layer made from a barrier material and an outer reinforcing layer made from a reinforcing material. The reinforcing layer in this embodiment is provided only on the longitudinal sides of the wall. No reinforcing layer is provided on the short sides, where the valves are also present. The wall there is formed solely by the barrier layer.

In a further embodiment of the invention, the hydrogen storage medium has a bottle-shaped configuration and likewise comprises a cavity in which hydrogen can be stored. The valves are provided at the top, i.e. on the opposite side from the base provided at the bottom. The reinforcing layer may be arranged all around the barrier layer. The hydrogen storage medium may alternatively be configured such that no reinforcing layer is provided in the upper region, in particular close to the valve, such that the wall is formed there solely by the barrier layer.

### Combination Material

A particularly preferred combination material of the present invention consists of a barrier material and a reinforcing material. In particular, the combination material is a layer composite composed of a barrier material and a reinforcing material. There follows a description in detail of an illustrative barrier material and an illustrative reinforcing material.

### Barrier Material

A suitable barrier material is in particular glass.

The tables below each list the compositions of some glasses in constituting phases, and the values calculated in accordance with the invention for density, CTE, packing density and H₂ permeability per mol/(m·s·Pa).

| | Composition in constituting | | | | | | Decadic |
|---|---|---|---|---|---|---|---|
| | phases/mol % | | | | | | logarithm of H₂ |
| | | | Sodium | Density/ | CTE/ | Packing | permeability per |
| | Silicon | | sheet | (g/cm³)), | (ppm/K), | density, | mol/(m · s · Pa), |
| # | dioxide | Nepheline | silicate | calculated | calculated | calculated | calculated |
| 1 | 100 | 0 | | 2.203 | 0.600 | 0.457 | −16.821 |
| 2 | 80 | 20 | | 2.264 | 2.872 | 0.469 | −17.524 |
| 3 | 58.4 | 41.6 | | 2.329 | 5.186 | 0.482 | −18.267 |
| 4 | 50.8 | 49.2 | | 2.351 | 5.967 | 0.486 | −18.524 |
| 5 | 42.8 | 57.2 | | 2.375 | 6.772 | 0.491 | −18.794 |
| 6 | 34.8 | 65.2 | | 2.398 | 7.560 | 0.495 | −19.060 |
| 7 | 18.8 | 81.2 | | 2.444 | 9.086 | 0.504 | −19.588 |
| 8 | 11.6 | 88.4 | | 2.465 | 9.753 | 0.508 | −19.817 |
| 9 | 4.4 | 95.6 | | 2.486 | 10.406 | 0.513 | −20.054 |
| 10 | 36.4 | 39.4 | 24.2 | 2.379 | 7.724 | 0.492 | −18.808 |
| 11 | 9.6 | 20 | 70.4 | 2.435 | 11.371 | 0.504 | −19.364 |

The materials shown are suitable in principle as barrier material. However, the hydrogen permeability is comparatively high. A particular problem is the discernible trend that specifically the materials having a relatively low hydrogen permeability have a relatively high CTE, and vice versa. Specifically the materials which, because of their moderate CTE, are of particularly good suitability for combination materials with the desired reinforcing materials are suboptimal with regard to their hydrogen permeability.

The materials shown in the table below are preferable in that they combine an appropriate CTE with a very low hydrogen permeability.

| | Composition in constituting | | | | | | | | Lg(H₂ |
|---|---|---|---|---|---|---|---|---|---|
| | phases/mol % | | | | | Density/ | CTE/ | Packing | permeability/ |
| | Silicon | | | | | (g/cm³)), | (ppm/K), | density, | mol/(m · s · Pa)), |
| # | dioxide | Eucryptite | Cordierite | Malinkoite | Kalsilite | calculated | calculated | calculated | calculated |
| 12 | | 100 | | | | 2.460 | 7.800 | 0.511 | −20.697 |
| 13 | 33.33 | 66.67 | | | | 2.371 | 5.773 | 0.496 | −19.631 |
| 14 | | | 100 | | | 2.626 | 3.560 | 0.522 | −21.451 |
| 15 | | | 60 | 30 | 10 | 2.593 | 6.758 | 0.554 | −23.189 |
| 16 | | 10 | 50 | 30 | 10 | 2.576 | 7.158 | 0.553 | −23.102 |
| 17 | 10 | | 60 | 20 | 10 | 2.556 | 5.814 | 0.539 | −22.188 |
| 18 | 10 | 10 | 60 | 20 | | 2.547 | 5.449 | 0.531 | −21.873 |
| 19 | 10 | | 50 | 30 | 10 | 2.548 | 6.603 | 0.547 | −22.674 |
| 20 | 10 | 10 | 50 | 30 | | 2.539 | 6.242 | 0.539 | −22.372 |
| 21 | 10 | 10 | 40 | 30 | 10 | 2.532 | 7.011 | 0.546 | −22.595 |
| 22 | 20 | 10 | 40 | 30 | | 2.494 | 6.074 | 0.532 | −21.865 |
| 23 | 20 | | 40 | 30 | 10 | 2.505 | 6.442 | 0.540 | −22.174 |
| 24 | | | 40 | 40 | 20 | 2.577 | 8.243 | 0.568 | −23.852 |
| 25 | | | 60 | 40 | 0 | 2.593 | 6.757 | 0.557 | −23.475 |
| 26 | | | 50 | 50 | 0 | 2.585 | 7.479 | 0.565 | −23.978 |
| 27 | | | 30 | 40 | 30 | 2.570 | 8.996 | 0.574 | −24.014 |
| 28 | | | 30 | 30 | 40 | 2.570 | 9.054 | 0.571 | −23.713 |

### Reinforcing Material

The reinforcing material is in particular a fibrous material, preferably carbon fibers and/or silicon carbide fibers. The combination material is thus preferably a fiber-reinforced glass.

### LIST OF REFERENCE NUMERALS

11, 21, 31a, 31b hydrogen storage medium
12, 22, 32a, 32b cavity
12, 23, 33a, 33b barrier layer
14, 24, 34a, 34b reinforcing layer
15, 16, 25, 26, 35a, 35b valve
37a, 37b base

1-13. (canceled)

14. A hydrogen storage medium, comprising:
a cavity; and
a wall surrounding the cavity, the wall comprising a combination material comprising a barrier material and a reinforcing material, the wall having a thickness of not more than 50 mm, and wherein a decadic logarithm of a hydrogen permeability p of the wall at a temperature of 473 K is less than −20.000.

15. The hydrogen storage medium of claim 14, wherein the barrier material is a two-dimensional material.

16. The hydrogen storage medium of claim 14, wherein the hydrogen storage medium is a mobile hydrogen storage medium.

17. The hydrogen storage medium of claim 14, wherein the wall has at least one opening.

18. The hydrogen storage medium of claim 14, wherein a total thickness variation of the wall is in a range from 0.1 to 10 mm.

19. The hydrogen storage medium of claim 14, wherein the wall has an inner layer and an outer layer.

20. The hydrogen storage medium of claim 14, further comprising one or more valves.

21. A combination material, comprising:
a barrier material; and
a reinforcing material, wherein a difference in an average linear coefficient of thermal expansion of the barrier material and of the reinforcing material in a range from 20° C. to 300° C. is not more than 10.0 ppm/K.

22. The combination material of claim 21, wherein the barrier material comprises glass and/or wherein the reinforcing material comprises carbon fibers and/or silicon carbide fibers.

23. The combination material of claim 21, wherein the barrier material is of laminar configuration.

24. The combination material of claim 23, wherein the barrier material is in the form of a film.

25. The combination material of claim 21, wherein the barrier material comprises a glass having the following components in the proportions specified (in mol %):

| | Min | Max |
|---|---|---|
| | (mol %) | (mol %) |
| SiO₂ | 50 | 75; |
| B₂O₃ | 0 | 25; |
| Al₂O₃ | 0 | 25; |
| MgO | 0 | 25; |
| Li₂O | 0 | 25; |
| Na₂O | 0 | 30; |
| K₂O | 0 | 25; |
| ΣR₂O | 0 | 30; |
| ΣRO | 0 | 25; |
| ΣR₂O + ΣRO | 10 | 30; |
| ΣLi₂O + MgO | 1 | 30; |

wherein a sum of the molar proportions of the alkali metal oxides R₂O and the alkaline earth metal oxides RO is equal to or greater than a sum of the molar proportions of B₂O₃ and Al₂O₃, wherein the composition of the glass is characterized by the following phases that constitute the glass:

| | Formula (normalized to | Min | Max |
|---|---|---|---|
| Constituting phase | a simple oxide) | (mol %) | (mol %) |
| Silicon dioxide | SiO₂ | 0 | 50; |
| Sodium sheet silicate | (3Na₂O•8SiO₂)/11 | 0 | 50; |
| Cordierite | (2MgO•2Al₂O₃•5SiO₂)/9 | 0 | 100; |
| Nepheline | (Na₂O•Al₂O₃•2SiO₂)/4 | 0 | 100; |
| Eucryptite | (Li₂O•Al₂O₃•2SiO₂)/4 | 0 | 100; |
| Malinkoite | (Na₂O•B₂O₃•2SiO₂)/4 | 0 | 100; |
| Kalsilite | (K₂O•Al₂O₃•2SiO₂)/4 | 0 | 40; |

and wherein a decadic logarithm of a hydrogen permeability p calculated according to the following formula is less than −20.000:
$$lg ( \frac{p}{mol / m \cdot s \cdot Pa} ) = - 44.525 \cdot {( \frac{G}{GP α} )}^{0.1} \cdot {χ}^{0.9} + 14.203 ,$$
wherein G is a shear modulus calculated according to the following formula
$$G = \frac{E}{2 ( 1 + μ )}$$
and χ is a packing density of the composition of the glass calculated according to the following formula:
$$χ = \frac{{\sum }_{i = 1}^{n} {c}_{i} \cdot {V}_{ion , i}}{{\sum }_{i = 1}^{n} {c}_{i} \cdot \frac{{M}_{i}}{{ρ}_{i}}} .$$

26. The barrier material of claim 25, wherein the glass has:
a CTE calculated according to the following formula in a range from 3.5 to 9.5 ppm/K:
$$CTE = \frac{{\sum }_{i = 1}^{n} {c}_{i} \cdot \frac{{M}_{i}}{{ρ}_{i}} \cdot {K}_{i} \cdot {CTE}_{i}}{{\sum }_{i = 1}^{n} {c}_{i} \cdot \frac{{M}_{i}}{{ρ}_{i}} \cdot {K}_{i}} ;$$
and/or
a density ρ calculated according to the following formula in a range from 2.20 to 2.70 g/cm³;
$$ρ = \frac{{\sum }_{i = 1}^{n} {c}_{i} \cdot {M}_{i}}{{\sum }_{i = 1}^{n} {c}_{i} \cdot \frac{{M}_{i}}{{ρ}_{i}}} ;$$
and/or
the packing density χ is at least 0.49; and/or
a modulus of elasticity E calculated according to the following formula is at least 60 GPa:
$$E = ( 1.745 \cdot ( \frac{\overline{{E}_{pot}} \cdot z}{{V}_{mot}} ) - 45.369 ) GP α .$$

27. The barrier material of claim 25, wherein the proportion of a residue in the glass is not more than 3.0 mol % and/or wherein the proportion of MgO is greater than the proportion of Li₂O and/or wherein the proportion of malinkoite is at least 1.0 mol % and/or wherein the proportion of cordierite is at least 1.0 mol % and/or wherein the sum of the proportions of cordierite and malinkoite is in a range from 50 to 100 mol %.
